(19) United States
(12) Patent Application Publication
(10) Pub. No.: US 2023/0298788 A1
(43) Pub. Date: Sep. 21, 2023

(54) FE-BASED NANOCRYSTAL SOFT MAGNETIC ALLOY AND MAGNETIC COMPONENT

(71) Applicants: NIPPON CHEMI-CON CORPORATION, Tokyo (JP); AKITA PREFECTURAL UNIVERSITY, Akita (JP)

(72) Inventors: Takashi MATSUOKA, Tokyo (JP); Nozomu KAMIYAMA, Tokyo (JP); Teruo BITOH, Akita (JP)

(21) Appl. No.: 18/006,371

(22) PCT Filed: Jul. 21, 2021
(86) PCT No.: PCT/JP2021/027366

§ 371 Date: Jan. 20, 2023

(30) Foreign Application Priority Data
Jul. 22, 2020 (JP) 2020-125629
Feb. 25, 2021 (JP) 2021-028332

(51) Int. Cl. H01F 1/153

(52) U.S. Cl. CPC H01F 1/15333; H01F 1/15308

(57) ABSTRACT

An Fe-based nanocrystalline soft magnetic alloy including an amorphous phase and crystal grains, wherein clusters are dispersed in the amorphous phase and the alloy has a composition represented by (Fe_{1-x-y}SiₓAl_{y})_{100-a-b-c}MₐM′_{b}Cu_{c} (M represents one or more elements selected from the group consisting of Nb, W, Zr, Hf, Ti and Mo; M′ represents one or more elements selected from the group consisting of B, C and P; a, b and c represent 2.0≤a≤5.0, 3.0<b<10.0 and 0<c<3.0, each in atomic %; and x and y represent 0.150≤x≤0.250 and 0.012≤y≤0.100 and satisfy 0.190≤x+y≤0.290).

### TECHNICAL FIELD

The present disclosure relates to a Fe-based nanocrystalline soft magnetic alloy and a magnetic component.

### BACKGROUND ART

With the active promotion of performance improvement, miniaturization, and weight reduction of electrical/electronic devices and information communication devices, there is a demand for miniaturization and efficiency improvement of power supply devices used in these various devices. Magnetic components used in power converters generally can be miniaturized by increasing the conversion frequency, but magnetic components for noise filters, such as common mode choke coils, can be miniaturized only by increasing the magnetic permeability of the material.

In recent years, as various electronic devices have become lighter, thinner, and smaller, a demand has been created for miniaturization of power converters such as noise filters. Therefore, it is strongly desired to improve the magnetic permeability in a high-frequency region of magnetic materials used especially for common mode choke coils and the like.

Development of magnetic materials exhibiting excellent high-frequency characteristics has heretofore been advanced, and for example, Fe—Si—B—Cu—Nb-based nanocrystalline soft magnetic materials including Fe as a main component are widely known (patent document 1).

### PRIOR ART DOCUMENT

### Patent Document

Patent Document 1: Japanese Patent Application Publication No. S64-79342

### SUMMARY OF INVENTION

### Problems to be Solved by the Invention

Magnetic permeability of magnetic materials is generally increased by setting both a magnetostriction k and a magnetocrystalline anisotropy K near zero. In patent document 1, the magnetocrystalline anisotropy is averaged and reduced and the magnetic permeability is greatly improved as compared with the conventional material by creating a nanocrystalline structure in a magnetic material. However, the intracrystalline composition is Fe—Si, and the magnetocrystalline anisotropy in individual crystals is not zero and does not necessarily become zero even if averaged.

An Fe—Si—Al-based magnetic material called Sendust is known as a magnetic material in which both magnetostriction and magnetocrystalline anisotropy are zero. However, in a magnetic material with a nanocrystalline structure, the relative volume ratio of grain boundary layers (amorphous phase) to the nanocrystals is large, and since this amorphous phase has positive magnetostriction, the magnetostriction of the entire material does not become zero even when the Sendust composition is used for the nanocrystalline soft magnetic material.

The present invention has been created in view of the above problems, and an object thereof is to provide a nanocrystalline soft magnetic material that exhibits high magnetic permeability in a high-frequency region.

### Means for Solving the Problem

As a result of repeated studies performed to solve the above problems, the present inventors have found that an Fe-based nanocrystalline soft magnetic alloy having a specific composition and dispersed clusters exhibits high magnetic permeability in a high-frequency region, and thus arrived at the present invention. That is, the gist of the present invention is as follows.
[1] An Fe-based nanocrystalline soft magnetic alloy comprising an amorphous phase and crystal grains, wherein
   clusters are dispersed in the amorphous phase and the alloy has a composition represented by a following general formula (I),

(Fe_{1-x-y}SiₓAl_{y})_{100-a-b-c}MₐM′_{b}Cu_{c} (I)
wherein in the formula (I), M represents one or more elements selected from the group consisting of Nb, W, Zr, Hf, Ti and Mo; M′ represents one or more elements selected from the group consisting of B, C and P; a, b and c represent 2.0≤a≤5.0, 3.0<b<10.0 and 0<c<3.0, each in atomic %; and x and y represent 0.150≤x≤0.250 and 0.012≤y≤0.100 and satisfy 0.190≤x+y≤0.290.
[2] The Fe-based nanocrystalline soft magnetic alloy according to [1], wherein
   in the general formula (I), a represents 2.0<a<5.0 in atomic %, and x and y represent 0.160≤x≤0.250 and 0.023≤y≤0.090 and satisfy 0.210≤x+y≤0.280.
[3] The Fe-based nanocrystalline soft magnetic alloy according to [1], wherein in the general formula (I), x and y represent 0.170≤x≤0.240 and 0.040≤y≤0.070 and satisfy 0.210≤x+y≤0.280.
[4] The Fe-based nanocrystalline soft magnetic alloy according to any one of [1] to [3], wherein M is Nb and M′ is B.
[5] The Fe-based nanocrystalline soft magnetic alloy according to any one of [1] to [4], wherein atoms constituting the clusters are either one or both of Cu and Al.
[6] The Fe-based nanocrystalline soft magnetic alloy according to [5], wherein the atoms constituting the clusters are both Cu and Al, and each cluster comprises both Cu and Al.
[7] The Fe-based nanocrystalline soft magnetic alloy according to any one of [1] to [6], wherein an average crystal grain size of the crystal grains is 11.3 nm or less.
[8] The Fe-based nanocrystalline soft magnetic alloy according to [7], wherein in the general formula (I), c and y satisfy c≥−34y+1.7.
[9] The Fe-based nanocrystalline soft magnetic alloy according to any one of [1] to [8], wherein a number density of the clusters is 1.65×10⁻⁴/nm³ or more and 7.3×10⁻⁴/nm³ or less.
[10] The Fe-based nanocrystalline soft magnetic alloy according to any one of [1] to [9], wherein the number of magnetic domain walls is 15/mm or more and 50/mm or less.
[11] A magnetic component comprising the Fe-based nanocrystalline soft magnetic alloy according to any one of [1] to [10].
[12] A method for producing the Fe-based nanocrystalline soft magnetic alloy according to any one of [1] to [10], the method comprising:
   an amorphous alloy preparation step of preparing an amorphous alloy by quenching and solidifying a molten metal having a composition represented by the general formula (I) by a rapid quenching method; and
   a heat treatment step of performing nanocrystallization by heat-treating the amorphous alloy at 500° C. to 700° C. for 5 min to 5 h.
[13] The method for producing the Fe-based nanocrystalline soft magnetic alloy according to [12], wherein a magnetic field is applied to the amorphous alloy during the heat treatment of the heat treatment step.
[14] The method for producing the Fe-based nanocrystalline soft magnetic alloy according to [13], wherein an angle formed by a magnetic path of the amorphous alloy and a magnetic field application direction in the magnetic field application is within a range of 90°±15°.
[15] The method for producing the Fe-based nanocrystalline soft magnetic alloy according to [13] or [14], wherein a magnetic field strength in the magnetic field application is 8 kA/m or more and 400 kA/m or less.
[16] A method for producing an Fe-based nanocrystalline soft magnetic alloy, the method comprising:
   an amorphous alloy preparation step of preparing an amorphous alloy by quenching and solidifying a molten metal having a composition represented by a general formula (II) by a rapid quenching method; and
   a heat treatment step of performing nanocrystallization by heat-treating the amorphous alloy at 500° C. to 700° C. for 5 min to 5 h, wherein
   a magnetic field is applied to the amorphous alloy during the heat treatment of the heat treatment step,

(Fe_{1-p-q}SiₚAl_{q})_{100-d-e-f}Q_{d}Q′ₑCu_{f} (II)
wherein in the formula (II), Q represents one or more elements selected from the group consisting of Nb, W, Zr, Hf, Ti and Mo; Q′ represents one or more elements selected from the group consisting of B, C and P; d, e and f represent 2.0≤d≤5.0, 3.0<e<10.0 and 0<f<3.0, each in atomic %; p and q represent 0.150≤p≤0.250 and 0.0020≤q<0.012 and satisfy 0.190≤p+q≤0.290.
[17] The method for producing the Fe-based nanocrystalline soft magnetic alloy according to [14], wherein an angle formed by a magnetic path of the amorphous alloy and a magnetic field application direction in the magnetic field application is within a range of 90°±15°.
[18] The method for producing the Fe-based nanocrystalline soft magnetic alloy according to [16] or [17], wherein a magnetic field strength in the magnetic field application is 8 kA/m or more and 400 kA/m or less.

### Advantageous Effects of Invention

According to the present invention, it is possible to provide a nanocrystalline soft magnetic material that exhibits high magnetic permeability in a high-frequency region.

### BRIEF DESCRIPTION OF DRAWINGS

FIG. 1 shows the relationship between the content ratios of Fe, Si, and Al in the Fe-based nanocrystalline soft magnetic alloys obtained in Examples 1 to 27 and Comparative Examples 1 to 14 and relative magnetic permeability.

FIG. 2 shows the results of observing the distribution of Si, Al, B and Cu in the Fe-based nanocrystalline soft magnetic alloy obtained in Example 11 with a three-dimensional atom probe (a photograph as a substitute for a drawing).

FIG. 3 shows the results of observing the distribution of each element contained in the Fe-based nanocrystalline soft magnetic alloy obtained in Example 11 with a three-dimensional atom probe (a photograph as a substitute for a drawing).

FIG. 4 shows the results of observing the distribution of each element contained in the Fe-based nanocrystalline soft magnetic alloy obtained in Example 11 with a three-dimensional atom probe (a photograph as a substitute for a drawing).

FIGS. 5(a) to 5(h) are polarization micrographs showing magnetic domain structures of Fe-based nanocrystalline soft magnetic alloys obtained in Comparative Example 18 and Examples 38, 39, 41, 44, 45, 46, and 47, respectively (a photograph as a substitute for a drawing).

FIG. 6 is a graph showing the relationship between the content ratio of Al in the Fe-based nanocrystalline soft magnetic alloys obtained in Comparative Example 18 and Examples 38, 39, 41, and 43 to 47, and the number of magnetic domain walls and relative magnetic permeability.

FIG. 7 is a graph showing the relationship between the ambient environment temperature and the rate of inductance change in the Fe-based nanocrystalline soft magnetic alloys obtained in Examples 1, 6, and 11 and Comparative Example 14.

FIG. 8 is a graph showing the relationship between the content ratios of Cu and Al in the Fe-based nanocrystalline soft magnetic alloys obtained in Examples 6, 11, 12, 39, 41, 43 to 46, and 60 to 71, Reference Examples 1 to 4, and Comparative Examples 30 to 33 and the average crystal grain size of the crystal grains.

FIGS. 9(a) and 9(b) are schematic diagrams showing the shape of a core.

### DESCRIPTION OF EMBODIMENTS

The embodiments of the present invention will be described in detail below. The description of the constituent elements described below is an example (representative example) of embodiments of the present invention, and the present invention is not specified by the contents thereof as long as the contents do not extend beyond the gist of the present invention.

1. Fe-Based Nanocrystalline Soft Magnetic Alloy

A first embodiment of the present invention is an Fe-based nanocrystalline soft magnetic alloy including an amorphous phase and crystal grains, wherein clusters are dispersed in the amorphous phase and the alloy has a composition represented by the following general formula (I).

(Fe_{1-x-y}SiₓAl_{y})_{100-a-b-c}MₐM′_{b}Cu_{c} (I)

In the general formula (I), M represents one or more elements selected from the group consisting of Nb, W, Zr, Hf, Ti and Mo; M′ represents one or more elements selected from the group consisting of B, C and P; a, b and c represent 2.0≤a≤5.0, 3.0<b<10.0 and 0<c<3.0, each in atomic %; and x and y represent 0.150≤x≤0.250 and 0.012≤y≤0.100 and satisfy 0.190≤x+y≤0.290.

That is, the Fe-based nanocrystalline soft magnetic alloy according to the present embodiment is a soft magnetic material in which atomic clusters and crystal grains of a crystalline phase are formed in an amorphous phase, the alloy exhibiting high magnetic permeability even in a high-frequency region. In the present description, “relative magnetic permeability” may be used as an index for evaluating “magnetic permeability”.

In the present description, the high-frequency region means a frequency region of 100 kHz or higher, for example. The Fe-based nanocrystalline soft magnetic alloy according to the present embodiment exhibits a high relative magnetic permeability of, for example, 21,000 or more, 25,000 or more, or 30,000 or more in this frequency region.

The relative magnetic permeability of the Fe-based nanocrystalline soft magnetic alloy can be calculated, for example, by measuring the inductance of a coil wound around a magnetic core of the Fe-based nanocrystalline soft magnetic alloy and using the following formula (1).

μr=μ/μ0 (1)
μr: relative magnetic permeability
μ0: magnetic permeability of vacuum=4π×10⁻⁷ [H/m]
μ: magnetic permeability [H/m]=Ll/A/N²
L: inductance [H]
l: magnetic path length [m]
A: core effective cross-sectional area [m²]
N: number of turns

1-1. Composition

The Fe-based nanocrystalline soft magnetic alloy according to the embodiment has a composition represented by the following general formula (I). However, this composition may include unavoidable impurities.

(Fe_{1-x-y}SiₓAl_{y})_{100-a-b-c}MₐM′_{b}Cu_{c} (I)

(M and M′)

In the general formula (I), M represents one or more elements selected from the group consisting of Nb, W, Zr, Hf, Ti and Mo, preferably Nb. Nb acts to increase the crystallization start temperature of the alloy and is also thought to have an effect of refining precipitated crystal grains, where the effect is brought about by formation of an amorphous phase grain boundary layer together with B in the crystallization process or by suppression of crystal grain growth by interaction of Nb with elements such as Cu that can form clusters and lower the crystallization start temperature.

In the general formula (I), M′ represents one or more elements selected from the group consisting of B, C and P. A certain amount of one or more elements selected from the group consisting of B, C and P is needed together with Si because the presence of such certain amount together with Si facilitates the formation of an amorphous structure in which the constituent elements are uniformly dispersed. Among these elements, since B is considered to be an effective element for forming fine crystal grains by forming grain boundary layers together with Nb in the crystallization process, M′ is preferably B.

From the above, from the viewpoint of obtaining fine crystal grains, it is particularly preferable that in the general formula (I), M be Nb and M′ be B.

(a, b and c)

a is usually 2.0 or more, preferably more than 2.0, more preferably 2.5 or more, and still more preferably 3.0 or more, and usually 5.0 or less, preferably less than 5.0, more preferably 4.5 or less, and even more preferably 4.0 or less. Most preferably, a is about 3.0.

b is usually more than 3.0, preferably 4.0 or more, more preferably 4.5 or more, and still more preferably 5.0 or more, and usually less than 10.0, preferably 9.5 or less, more preferably 9.0 or less, and even more preferably 7.0 or less.

c is usually more than 0, preferably 0.3 or more, more preferably 0.5 or more, and still more preferably 0.7 or more, and is usually less than 3.0, preferably 2.5 or less, more preferably 2.0 or less, even more preferably 1.5 or less, and particularly preferably 1.2 or less. Most preferably, c is about 1.0.

By setting a to c within the above ranges, crystal grains with a small average crystal grain size are easily formed, and the magnetocrystalline anisotropy of the Fe-based nanocrystalline soft magnetic alloy can be reduced. Therefore, an Fe-based nanocrystalline soft magnetic alloy that exhibits high relative magnetic permeability can be obtained. In addition, since the crystal grains can be refined in this way, it is also possible to improve soft magnetic properties such as magnetic permeability and coercive force of the Fe-based nanocrystalline soft magnetic alloy.

When M′ is B, by setting b in the above range, the amorphous phase formation ability can be ensured, the precipitation of Fe—B binary compounds, which are inferior in magnetic properties, is suppressed, and excellent soft magnetic properties can be realized.

Further, when c is within the above range, the amorphous phase formation ability can be ensured and the preparation of an amorphous alloy by a rapid quenching method, which will be described hereinbelow, is facilitated. In addition, when c is within the above range, clusters including Cu are easily formed uniformly in the amorphous phase prior to crystallization of α-Fe(Si, Al), and the clusters can serve as crystal nuclei to form fine crystal grains.

In addition, in the present embodiment, the composition of the alloy used as the raw material of the Fe-based nanocrystalline soft magnetic alloy (that is, the composition of the molten metal) and the composition of the obtained Fe-based nanocrystalline soft magnetic alloy are assumed to be the same.

(x and y)

x and y indicate the molar amounts of Si and Al, respectively, when the molar amount of Fe, Si and Al in the Fe-based nanocrystalline soft magnetic alloy is taken as 1. Further, when the molar amount of Fe, Si and Al in the Fe-based nanocrystalline soft magnetic alloy is taken as 1, the molar amount of Fe is represented by 1−(x+y).

x is usually 0.150 or more, preferably 0.160 or more, and more preferably 0.170 or more, and is usually 0.250 or less, preferably 0.245 or less, more preferably 0.240 or less, and further preferably 0.220 or less.

y is usually 0.012 or more, preferably 0.020 or more, more preferably 0.023 or more, still more preferably 0.040 or more, and may be 0.050 or more, and is usually 0.100 or less, preferably 0.090 or less, and more preferably 0.070 or less.

In addition, x+y is usually 0.190 or more, preferably 0.210 or more, and more preferably 0.215 or more, and is usually 0.290 or less, preferably 0.280 or less, more preferably 0.275 or less, even more preferably 0.270 or less, and particularly preferably 0.265 or less.

When x is within the above range, the amorphous phase formation ability can be ensured, and the preparation of an amorphous alloy by a rapid quenching method, which will be described hereinbelow, is facilitated. In addition, it is possible to prevent the magnetocrystalline anisotropy in crystal grains from increasing and the negative magnetostriction from being too large, and good soft magnetic properties can be realized.

Further, when y satisfies the above numerical range, the magnetocrystalline anisotropy of the crystalline phase of the Fe—Si—Al ternary alloy in the crystal grains is reduced and a sufficient number of Al-containing clusters are formed facilitating the formation of crystal grains with a small crystal grain size. Therefore, the magnetocrystalline anisotropy of the Fe-based nanocrystalline soft magnetic alloy can be reduced, and soft magnetic properties such as magnetic permeability and coercive force can be improved. Furthermore, the magnetostriction of the Fe-based nanocrystalline soft magnetic alloy can also be reduced. Therefore, by setting x and y within the above ranges, an Fe-based nanocrystalline soft magnetic alloy exhibiting a high relative magnetic permeability can be obtained.

1-2. Amorphous Phase and Crystal Grains

In the Fe-based nanocrystalline soft magnetic alloy according to the present embodiment, crystal grains of a crystalline phase are formed, and the remainder thereof is an amorphous phase in which clusters are dispersed.

More specifically, the volume fraction of crystal grains in the alloy structure is usually 50% or more, preferably 65% or more, and more preferably 69% or more, and usually 90% or less, preferably 85% or less, and more preferably 80% or less, and the rest is occupied by an amorphous phase in which clusters are dispersed.

The volume fraction of crystal grains can be obtained by the following method. That is, the volume fraction can be determined according to the following formula (2) by performing analysis using an X-ray diffractometer (XRD).

X=Ic/(Ic+Ia)×100 (2)
X: volume fraction of crystalline phase
Ic: crystalline integrated scattering intensity
Ia: amorphous integrated scattering intensity

The crystal grains are made of a crystalline phase of a Fe—Si—Al ternary system alloy having a body-centered cubic structure (bcc structure), in which Si and Al are solid-dissolved in Fe, which is the main component, and other elements may also be solid-dissolved therein. The magnetocrystalline anisotropy of the Fe-based nanocrystalline soft magnetic alloy can be reduced by including a specific amount of Al in the composition, and it is considered that since the magnetocrystalline anisotropy is also averaged and reduced due to refinement of crystal grains, the relative magnetic permeability is improved.

The crystal structure of the crystalline phase that constitutes the crystal grains can be identified by an X-ray diffraction method (XRD).

The average crystal grain size of the crystal grains is not particularly limited as long as it is nanoscale, and is usually 9.0 nm or more, and is usually 20.0 nm or less, preferably 12.0 nm or less, more preferably 11.3 nm or less, even more preferably 11.0 nm or less, and particularly preferably 10.0 nm or less. Alternatively, it is usually 9 nm or more and usually 20 nm or less, preferably 12 nm or less, and more preferably 11 nm or less.

By setting the average crystal grain size of the crystal grains within the above ranges, the magnetocrystalline anisotropy tends to be averaged and reduced and the effect of improving the relative magnetic permeability tends to increase. In addition, since the crystal grains are thus fine, it is also possible to improve soft magnetic properties such as magnetic permeability and coercive force of the Fe-based nanocrystalline soft magnetic alloy.

The average crystal grain size of the crystal grains can be obtained according to a following formula (3) by analyzing the Fe-based nanocrystalline soft magnetic alloy with an X-ray diffractometer (XRD).

D=(K×λ)/(β×cos θ) (3)
D: crystal grain size [nm]
K: Scherrer constant
λ: X-ray wavelength [nm]
β: half-value width [rad]
θ: Bragg angle [rad]

A correlation is observed between the average crystal grain size of the crystal grains and the composition represented by general formula (I). In particular, when the relationship between c and y related to the content ratios of Cu and Al is represented by a following formula (4), the average crystal grain size of the crystal grains tends to vary depending on Z in the formula (4). More specifically, when Z is 1.7, 2.2 and 3.2 in the formula (4), the average crystal grain size of the crystal grains is about 11.3 nm, about 11.0 nm, and about 10.0 nm, respectively.

c=−34y+Z (4)

In addition, when c and y satisfy the relational expression of c≥−34y+2.2, the average crystal grain size of the crystal grains is 11.0 nm or less, and when the relational expression of c≥−34y+3.2 is satisfied, the average crystal grain size of the crystal grains tends to be 10.0 nm or less. Also, when the relational expression of c≤−34y+4.5 is satisfied, the average crystal grain size of the crystal grains tends to be 9.0 nm or more.

1-3. Clusters

In the Fe-based nanocrystalline soft magnetic alloy according to the present embodiment, clusters are dispersed in the amorphous phase. In the present description, a cluster refers to an aggregate of atoms observable by a three-dimensional atom probe (3DAP). The clusters may be distributed uniformly or unevenly in the Fe-based nanocrystalline soft magnetic alloy but are preferably distributed uniformly.

The types of atoms that make up the cluster are not particularly limited as long as they are atoms other than Fe, which is the main component of the Fe-based nanocrystalline soft magnetic alloy, and atoms of at least one type selected from the group consisting of Si, Al, Nb, W, Zr, Hf, Ti, Mo, B, C, P, and Cu. Among these atoms, the atoms forming the cluster are preferably one or both of Cu and Al, more preferably both Cu and Al. Cu is an element that forms a cluster because it does not form a solid solution with Fe, and Al is presumed to be an element that is likely to form a cluster by forming a solid solution or a compound with Cu.

When two or more types of atoms constitute clusters, each cluster may be an aggregate of one type of atom or an aggregate of two or more types of atoms, but an aggregate of two or more types of atoms is preferable. More specifically, when the atoms constituting the clusters include both Cu and Al, Cu clusters and Al clusters may be dispersed and clusters including both Cu and Al may be dispersed in the amorphous phase of the Fe-based nanocrystalline soft magnetic alloy, but it is preferable that clusters including both Cu and Al be dispersed.

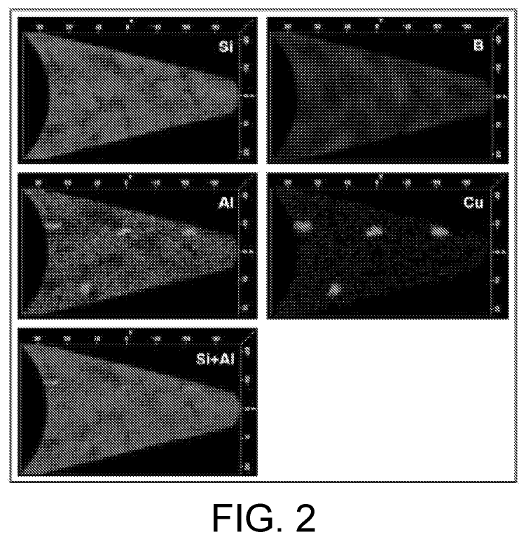

In addition, as shown in the Examples (FIG. 2) described hereinbelow, where a portion corresponding to a cluster in the distribution of Cu and a portion corresponding to a cluster in the distribution of Al overlap in structure observation using a three-dimensional atom probe (3DAP), it is considered that clusters including both Cu and Al are dispersed in the amorphous phase of the Fe-based nanocrystalline soft magnetic alloy.

Here, as will be described hereinbelow, the Fe-based nanocrystalline soft magnetic alloy is produced by heat-treating an amorphous alloy to form clusters and crystal grains in the structure, the clusters are formed in the amorphous alloy at the initial stage of heat treatment, and in addition to causing the growth of the crystalline phase by serving as crystal nuclei, the clusters can be dispersed around the crystalline phase to suppress excessive crystal growth. It is considered that this is why an Fe-based nanocrystalline soft magnetic alloy including crystal grains with a small crystal grain size can be obtained. In addition, it is considered that fine clusters are dispersed in the amorphous phase, so that magnetocrystalline anisotropy is reduced and an Fe-based nanocrystalline soft magnetic alloy with high relative magnetic permeability is obtained. A cluster of either one or both of Cu and Al is preferable in that such action is high.

The number density of clusters in the Fe-based nanocrystalline soft magnetic alloy is usually 1.65×10⁻⁴/nm³ or more, preferably 1.90×10⁻⁴/nm³ or more, more preferably 2.15×10⁻⁴/nm³ or more, and even more preferably 2.50×10⁻⁴/nm³ or more, and usually 7.30×10⁻⁴/nm³ or less, preferably 5.50×10⁻⁴/nm³ or less, and even more preferably 3.00×10⁻⁴/nm³ or less.

The number density of clusters can be determined by using three-dimensional mapping obtained by three-dimensional atom probe (3DAP) analysis of the Fe-based nanocrystalline soft magnetic alloy and confirming the number of clusters per unit area. At this time, when one type of atoms accounts for 20 atomic % or more of the atoms constituting a cluster, the cluster is counted as one cluster of those atoms. In addition, when two types of atoms account for 20 atomic % or more of atoms constituting a cluster, the cluster is counted as one cluster including both types of atoms.

By keeping the average size and number density of clusters within the above ranges, that is, by allowing many small clusters to exist, the distance between the clusters is narrowed. As a result, the growth of the crystalline phase generated with clusters as crystal nuclei is suppressed, and an Fe-based nanocrystalline soft magnetic alloy including crystal grains with a small average crystal grain size can be obtained. As a result, high relative magnetic permeability can be achieved.

The average size and number density of the clusters, particularly the number density, can be adjusted by varying the composition represented by the general formula (I). For example, when forming a cluster including both Cu and Al, the adjustment can be performed by changing c, y, and y×(100−a−b−c) in the general formula (I).

1-4. Magnetic Domain Walls

In the Fe-based nanocrystalline soft magnetic alloy according to the present embodiment, the number of magnetic domain walls, which are spaces where the magnetic moment of atoms present between magnetic domains is continuously reversed, is greater than that in the conventional Fe-based nanocrystalline soft magnetic alloys. Specifically, the number of magnetic domain walls in the Fe-based nanocrystalline soft magnetic alloy according to the embodiment is usually 10/mm or more, preferably 15/mm or more, and more preferably 20/mm or more, and usually 50/mm or less, and preferably 40/mm or less.

The number of magnetic domain walls is determined by observing the magnetic domain structure of the Fe-based nanocrystalline soft magnetic alloy with a polarizing microscope that utilizes a magnetic Kerr effect, measuring the number of magnetic domain walls present per arbitrary 1 mm at 5 points to 10 points, and finding the average value.

The number of magnetic domain walls depends on the composition of the soft magnetic alloy. Therefore, in the present embodiment, the number of magnetic domain walls varies depending on the composition represented by the general formula (I), especially the content ratio of Al. In particular, where the content ratio of Al in the ratio of the three elements of Fe, Si and Al, that is, y in the general formula (I), is set in the range of 0.012 or more and 0.100 or less, the number of magnetic domain walls becomes 10/mm or more, which is larger than that when the content ratio of Al is 0, as shown in the Examples hereinbelow. Further, when y in the general formula (I) is within a preferred range of 0.023 or more and 0.090 or less, the number of magnetic domain walls becomes 15/mm or more which is even greater. Alternatively, where the content ratio of Al in the composition represented by the general formula (I) is set to more than 0 atomic %, preferably 1.0 atomic % or more, the number of magnetic domain walls becomes 10/mm or more. Further, where the content ratio of Al in the composition represented by the general formula (I) is set to 3.0 atomic % or more, preferably 4.0 atomic % or more, and 7.5 atomic % or less, and preferably 7.0 atomic % % or less, the number of magnetic domain walls becomes 15/mm or more. In addition, as shown in the Examples described hereinbelow, the Fe-based nanocrystalline soft magnetic alloy having a number of magnetic domain walls of 15/mm or more also has a high relative magnetic permeability.

The inventors infer that a large number of magnetic domain walls in the Fe-based nanocrystalline soft magnetic alloy according to the present embodiment can be attributed to the following reason.

Elements that affect the magnetic domain structure include magnetostatic energy, magnetic anisotropic energy, elastic energy due to magnetostriction, magnetic domain wall energy, and exchange energy. Among them, the magnetic domain wall energy increases as the magnetic domains are subdivided and the number of magnetic domain walls increases. Meanwhile, in the Fe-based nanocrystalline soft magnetic alloy according to the present embodiment, crystals are refined particularly due to the content ratio of Al being within a specific range, so that the magnetocrystalline anisotropy is averaged and reduced to near zero. This reduction in magnetocrystalline anisotropy results in a reduction in magnetic domain wall energy. Magnetostatic energy is also reduced by subdivision of the magnetic domains. Based on these facts, it is considered that in the present embodiment, since the amount of magnetostatic energy that is reduced due to subdivision of the magnetic domains is larger than the amount of increase in the magnetic domain wall energy due to enlargement of magnetic domain walls, the subdivision of the magnetic domains, which is more stable in terms of energy, is advanced. It is inferred that this is why the number of magnetic domain walls in the Fe-based nanocrystalline soft magnetic alloy according to the present embodiment increases.

2. Method for Producing Fe-based Nanocrystalline Soft Magnetic Alloy

A method for producing the Fe-based nanocrystalline soft magnetic alloy according to the present embodiment is not particularly limited, and for example, may include an amorphous alloy preparation step of preparing an amorphous alloy by quenching and solidifying a molten metal having a composition represented by the general formula (I) by a rapid quenching method, and a heat treatment step of performing nanocrystallization by heat-treating the amorphous alloy at a temperature equal to or higher than the crystallization start temperature.

In the above method, the composition of the alloy to be subjected to the rapid quenching method is represented by the general formula (I) similarly to the Fe-based nanocrystalline soft magnetic alloy to be obtained, and is selected according to the characteristics of the target Fe-based nanocrystalline soft magnetic alloy. For example, c and y in the general formula (I) may be determined based on the formula (4) from the viewpoint of adjusting the average crystal grain size of the crystal grains to a desired size, and the content ratio of Al may be determined from the viewpoint of adjusting the number of magnetic domain walls to a desired range.

In addition, it is desirable that the temperature of the molten metal during quenching be about 50° C. to 300° C. higher than the melting point of the alloy. The rapid quenching method is not particularly limited, and known methods such as a single roll method, a twin roll method, an in-rotating liquid spinning method, a gas atomization method, and a water atomization method can be employed.

The preparation of the amorphous alloy by the rapid quenching method may be carried out in an oxidizing atmosphere such as air, in an atmosphere of an inactive gas such as argon, helium, or nitrogen, or under vacuum conditions.

The shape of the obtained amorphous alloy is not particularly limited, but the alloy is usually ribbon-shaped. The amorphous alloy obtained by quenching of the molten metal preferably does not include a crystalline phase but may partially contain a crystalline phase.

The amorphous alloy obtained by the rapid quenching method can be processed into a desired shape, as necessary, before heat treatment. Specific processing methods include winding, punching, etching, and the like. Processing for obtaining a magnetic material of a desired shape may be performed after heat treatment but is preferably performed before heat treatment. This is because, although the alloy exhibits good workability at the amorphous alloy stage, the workability decreases when the alloy is nano-crystallized by heat treatment.

The heat treatment temperature is equal to or higher than the crystallization start temperature of the alloy. Specifically, it is usually 500° C. or higher, preferably 530° C. or higher, and more preferably 550° C. or higher, and usually 700° C. or lower, preferably 650° C. or lower, and more preferably 600° C. or lower. The heat treatment temperature, as referred to herein, means the highest temperature reached in the heat treatment. The holding time at the heat treatment temperature depends on the shape of the amorphous alloy, etc., but from the viewpoint of uniformly heating the entire alloy and the viewpoint of productivity, the holding time is usually 5 min or more, preferably 8 min or more, and more preferably 10 min or more. The holding time is generally 5 h or less, preferably 3 h or less, more preferably 2 h or less, and still more preferably 1 h or less.

The heat treatment may be performed in an oxidizing atmosphere such as air, may be performed in an inactive gas atmosphere such as argon, helium, nitrogen, or may be performed under vacuum conditions. The heat treatment is preferably performed in an inactive gas atmosphere.

At the initial stage of heat treatment, clusters are formed in the amorphous alloy, and crystal grains grow using the clusters as crystal nuclei. Here, it is considered that since the Fe-based nanocrystalline soft magnetic alloy according to the present embodiment has the composition represented by the general formula (I), a sufficient number of clusters are formed, so that the distance between the clusters is narrowed, the crystal growth is suppressed, and grain refinement becomes possible.

In addition, in the heat treatment step, from the viewpoint of obtaining the effect of improving the magnetic permeability by subdividing the magnetic domains, it is preferable to apply a magnetic field to the amorphous alloy during the heat treatment. By applying a magnetic field during the heat treatment of the amorphous alloy having the composition represented by the general formula (I), the magnetic permeability can be further improved. The heat treatment causes nanocrystallization, and the formation of fine crystal grains proceeds in the amorphous alloy, but in the present description, an amorphous alloy including such growing crystal grains is also referred to as an “amorphous alloy” for convenience.

The timing of applying the magnetic field may be part or all of the time from the start to the end of the heat treatment. Further, when the magnetic field is applied during a part of the time from the start to the end of the heat treatment, the magnetic field may be applied continuously or intermittently. Alternatively, when the magnetic field is applied during a part of the time from the start to the end of the heat treatment, the magnetic field may be applied after a predetermined time has passed since the start of the heat treatment and crystal grains have been formed. At this time, after the crystal grains are formed, the magnetic field may be applied after cooling and reheating the amorphous alloy. The timing for applying the magnetic field is preferably part or all of the time during which the heat treatment temperature is maintained, and preferably all of the time during which the heat treatment temperature is maintained.

The strength of the magnetic field applied to the amorphous alloy is not particularly limited as long as the amorphous alloy is magnetically saturated, and is usually 8 kA/m or more, preferably 16 kA/m or more, and more preferably 24 kA/m or more. Also, the strength of the magnetic field is usually 400 kA/m or less, preferably 320 kA/m or less, more preferably 240 kA/m or less, still more preferably 160 kA/m or less, and particularly preferably 80 kA/m or less.

The direction in which the magnetic field is to be applied is not particularly limited, and may be any direction. For example, when a ribbon-shaped amorphous alloy is produced by a rapid quenching method and processing of winding the ribbon is performed before heat treatment, by applying the magnetic field in the diameter direction of the wound body (that is, the direction parallel to the magnetic path), the squareness ratio of the magnetization curve is improved and magnetic properties at low frequencies are improved, but it is preferable to apply the magnetic field in the height direction of the wound body (that is, the width direction of the ribbon). That is, where the angle formed by the magnetic path of the amorphous alloy and the magnetic field application direction in the magnetic field application is usually within the range of 90°±15°, preferably 90°±10°, and more preferably 90°±5°, the squareness ratio of the magnetization curve is reduced, but the magnetic permeability in a high-frequency region is improved. In particular, in the Fe-based nanocrystalline soft magnetic alloy according to the present embodiment, the magnetic permeability is improved not only in a high-frequency region but also in a low-frequency region of 100 kHz or less. As a result, it is possible to produce a magnetic core (core) of a Fe-based nanocrystalline soft magnetic alloy with high magnetic permeability from a low-frequency region to a high-frequency region. It is considered that this is because magnetic domains are subdivided by applying a magnetic field, and magnetic permeability determined by the magnetic domain wall motion is improved.

3. Method for Producing Fe-based Nanocrystalline Soft Magnetic Alloy

The second embodiment of the present invention is a method for producing an Fe-based nanocrystalline soft magnetic alloy represented by the following general formula (II), the method including: an amorphous alloy preparation step of preparing an amorphous alloy by quenching and solidifying a molten metal having a composition represented by the general formula (II) by a rapid quenching method, and a heat treatment step of performing nanocrystallization by heat-treating the amorphous alloy a temperature equal to or higher than the crystallization start temperature, wherein a magnetic field is applied to the amorphous alloy during the heat treatment. With the production method according to the present embodiment, an Fe-based nanocrystalline soft magnetic alloy in which clusters are dispersed in the amorphous phase and which has the same composition as that of the general formula (II) is obtained. The composition represented by the general formula (II) may contain unavoidable impurities.

(Fe_{1-p-q}SiₚAl_{q})_{100-d-e-f}Q_{d}Q′ₑCu_{f} (II)

(Q and Q′)

In the general formula (II), Q represents one or more elements selected from the group consisting of Nb, W, Zr, Hf, Ti and Mo, preferably Nb. Nb acts to increase the crystallization start temperature of the alloy and is also thought to have an effect of refining precipitated crystal grains, where the effect is brought about by formation of an amorphous phase grain boundary layer together with B during nanocrystallization or by suppression of crystal grain growth by interaction of Nb with elements such as Cu that can form clusters and lower the crystallization start temperature. It is considered that where the crystal grains are refined, the magnetocrystalline anisotropy is averaged and reduced, so that an Fe-based crystalline soft magnetic alloy having high relative magnetic permeability can be produced.

In the general formula (II), Q′ represents one or more elements selected from the group consisting of B, C and P. A certain amount of one or more elements selected from the group consisting of B, C and P is needed together with Si because the presence of such certain amount together with Si facilitates the formation of an amorphous structure in which the constituent elements are uniformly dispersed. Among these elements, since B is considered to be an effective element for forming fine crystal grains by forming grain boundary layers together with Nb during nanocrystallization, Q′ is preferably B.

From the above, from the viewpoint of obtaining fine crystal grains, it is particularly preferable that in the general formula (II), Q be Nb and Q′ be B.

(d, e and f)

d is usually 2.0 or more, preferably more than 2.0, more preferably 2.5 or more, and still more preferably 3.0 or more, and usually 5.0 or less, preferably less than 5.0, more preferably 4.5 or less, and even more preferably 4.0 or less. Most preferably, d is about 3.0.

e is usually more than 3.0, preferably 4.0 or more, more preferably 4.5 or more, and still more preferably 5.0 or more, and usually less than 10.0, preferably 9.5 or less, more preferably 9.0 or less, and even more preferably 7.0 or less.

f is usually more than 0, preferably 0.3 or more, more preferably 0.5 or more, and still more preferably 0.7 or more, and is usually less than 3.0, preferably 2.5 or less, more preferably 2.0 or less, even more preferably 1.5 or less, and particularly preferably 1.2 or less. Most preferably, f is about 1.0.

By setting d to f within the above ranges, crystal grains with a small average crystal grain size are easily formed during nanocrystallization, and the magnetocrystalline anisotropy can be reduced. It is considered that this is why an Fe-based nanocrystalline soft magnetic alloy that exhibits high relative magnetic permeability can be obtained. In addition, where crystal grain refinement is achieved, it is also possible to improve soft magnetic properties such as magnetic permeability and coercive force of the Fe-based nanocrystalline soft magnetic alloy.

It is considered that when Q′ is B, by setting e in the above range, the amorphous phase formation ability can be ensured, the precipitation of Fe—B binary compounds, which are inferior in magnetic properties, is suppressed, and soft magnetic properties are improved.

Further, when f is within the above range, the amorphous phase formation ability can be ensured and the preparation of an amorphous alloy by a rapid quenching method is facilitated. In addition, it is considered that when f is within the above range, clusters including Cu are easily formed uniformly in the amorphous phase prior to crystallization of α-Fe(Si, Al), and the clusters can serve as crystal nuclei to form fine crystal grains.

(p and q)

p and q indicate the molar amounts of Si and Al, respectively, when the molar amount of Fe, Si and Al in the composition represented by the general formula (II) is taken as 1. Further, when the molar amount of Fe, Si and Al in the composition represented by the general formula (II) is taken as 1, the molar amount of Fe is represented by 1−(p+q).

p is usually 0.150 or more, preferably 0.160 or more, and more preferably 0.170 or more, and is usually 0.250 or less, preferably 0.245 or less, more preferably 0.240 or less, and further preferably 0.220 or less.

q is usually 0.0020 or more, preferably 0.0050 or more, and more preferably 0.010 or more, and is usually less than 0.012, preferably 0.011 or less.

In addition, p+q is usually 0.190 or more, preferably 0.210 or more, and more preferably 0.215 or more, and is usually 0.290 or less, preferably 0.280 or less, more preferably 0.275 or less, even more preferably 0.270 or less, and particularly preferably 0.265 or less.

For the conditions for quenching and solidification by the rapid quenching method, the shape of the amorphous alloy prepared by quenching and solidification, the processing of the amorphous alloy that can be performed before the heat treatment, the heat treatment conditions, and the conditions for applying a magnetic field in the present embodiment, the description given in the “2. Method for Producing Fe-based Nanocrystalline Soft Magnetic Alloy” section related to the Fe-based nanocrystalline soft magnetic alloy according to the first embodiment of the present invention is used.

4. Magnetic Component

The Fe-based nanocrystalline soft magnetic alloy according to the first embodiment of the present invention and the Fe-based nanocrystalline soft magnetic alloy obtained by the production method according to the second embodiment of the present invention can be used for various magnetic components such as reactors, common mode choke coil, transformers, pulse transformers for communication, magnetic cores of motors or generators, yoke materials, current sensors, magnetic sensors, antenna magnetic cores, and electromagnetic wave absorbing sheets. Among these, the Fe-based nanocrystalline soft magnetic alloys are particularly suitable for applications such as common mode choke coils, zero-phase reactors, current transformers, and ground fault sensors that require high relative magnetic permeability at high frequencies.

Here, regarding common mode choke coils, it is necessary to save resources by miniaturization without lowering the inductance that indicates the performance thereof; to reduce cost; to reduce energy consumption by reducing loss and decrease CO₂ emissions; and the like. In order to miniaturize a common mode choke coil, it is necessary to use a material with high magnetic permeability for the core, and the Fe-based nanocrystalline soft magnetic alloy according to the first embodiment of the present invention and the Fe-based nanocrystalline soft magnetic alloy obtained by the production method according to the second embodiment of the present invention are useful because these alloys exhibit high magnetic permeability. Also, in order to reduce the production cost and loss, it is effective to reduce the number of winding turns to shorten the winding length which causes copper loss. The inductance of a common mode choke coil is given by a following formula (5). From this formula (5), it is understood that in order to reduce the number of turns without lowering the inductance, the magnetic permeability may be increased and also the cross-sectional area may be increased and the magnetic path length may be shortened.

L=μ(Ae/le)N² (5)
L: inductance [H]
le: magnetic path length [m]
Ae: core cross-sectional area [m²]
N: number of turns

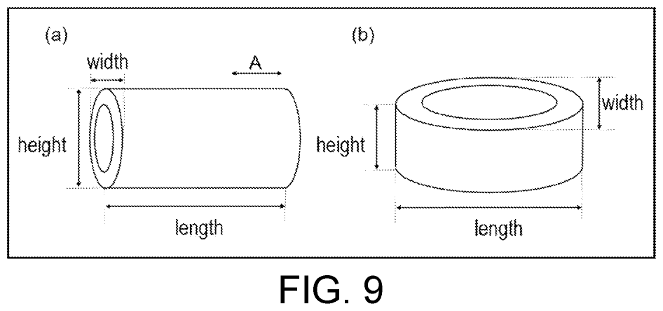

A core shape with a large cross-sectional area and a short magnetic path length can be exemplified by a cylindrical shape shown in FIG. 9(a). However, where the magnetic path length is shortened, the length of the cylindrical shape in the major axis direction (direction A in FIG. 9(a)) should be expanded in order to increase the cross-sectional area, and the requirement to miniaturize the coil cannot be met. Thus, since there is a limit to shortening the magnetic path length and expanding the cross-sectional area, it is necessary to form the core from a material with high magnetic permeability in order to reduce the number of turns in a small core. With the conventional materials, the magnetic permeability is not sufficient, and where the number of turns is reduced, it is not possible to achieve a practical level of inductance, but the Fe-based nanocrystalline soft magnetic alloy according to the first embodiment of the present invention and the Fe-based nanocrystalline soft magnetic alloy obtained by the production method according to the second embodiment of the present invention have a higher magnetic permeability than the conventional materials, so it is possible both to ensure high inductance and to reduce the number of turns in a small core.

By using the Fe-based nanocrystalline soft magnetic alloy according to the first embodiment of the present invention and the Fe-based nanocrystalline soft magnetic alloy obtained by the production method according to the second embodiment of the present invention as core materials, the number of turns can be reduced with respect to that in the conventional products, specifically, to 8 turns, 6 turns, 4 turns, 2 turns, etc., without impairing the characteristics of the common mode choke coil. For example, as shown in the Examples described hereinbelow, a common mode choke coil of a two-turn structure (2 turns) having a core that is shaped as shown in FIG. 9(a) and formed of the Fe-based nanocrystalline soft magnetic alloy according to the first embodiment of the present invention is reduced in size, weight and loss as compared with a general-purpose common mode choke coil having a core shaped as shown in FIG. 9(b), and exhibits equivalent inductance.

From the above, a common mode choke coil can be reduced in size, cost, and loss by using the Fe-based nanocrystalline soft magnetic alloy according to the first embodiment of the present invention and the Fe-based nanocrystalline soft magnetic alloy obtained by the production method according to the second embodiment of the present invention as core materials shaped as shown in FIG. 9(a) and reducing the number of winding turns. In addition, since the number of winding turns is small, the material cost is reduced, the processing of the winding is facilitated, and the production load is reduced. In addition, disassembling at the time of discarding is facilitated and material recycling is promoted. Therefore, according to the first and second embodiments of the present invention, it is possible to provide an environmentally friendly Fe-based nanocrystalline soft magnetic alloy that contributes to SDGs.

### EXAMPLES

The present invention will be described in more detail below with reference to the Examples, but the present invention is not limited to the description of the Examples below as long as this description does not extend beyond the gist of the present invention.

### Examples 1 to 27 and Comparative Examples 1 to 13

An alloy ribbon was produced from each of the molten metals having the compositions shown in Table 1 by a single-roll method. Specifically, pure metals of each element weighed to obtain the composition shown in Table 1 were melted and mixed by an arc melting method to obtain a master alloy. An alloy melt obtained by melting the obtained master alloy was ejected onto a roll rotating at a peripheral speed of 50 m/s under reduced pressure in an argon gas atmosphere to prepare a ribbon having a width of 5 mm and a thickness of 10 μm.

Subsequently, the resulting ribbon was wound to obtain a wound magnetic core with an outer diameter of 13 mm, an inner diameter of 12 mm and a height of 5 mm. A core of an Fe-based nanocrystalline soft magnetic alloy was produced by heat-treating the obtained magnetic core thus obtained at 550° C. for 1 h in a nitrogen atmosphere.

### Comparative Example 14

A core was produced in the same manner as in Example 1, except that a molten metal having a composition represented by Fe_{73.5}Si_{16.5}Nb₃B₆Cu₁ was used. The alloy having the composition represented by Fe_{73.5}Si_{16.5}Nb₃B₆Cu₁ is a conventional soft magnetic material described in patent document 1.

### Comparative Example 15

A wound magnetic core was obtained in the same manner as in Example 1, except that a molten metal having the composition shown in Table 1 was used. A core of an Fe-based nanocrystalline soft magnetic alloy was produced by heat-treating the obtained wound magnetic core at 545° C. for 60 min in a nitrogen atmosphere.

### Examples 29 to 37 and Comparative Examples 16 to 17

Wound magnetic cores were obtained in the same manner as in Example 1, except that molten metals having the compositions shown in Table 1 were used. Cores of Fe-based nanocrystalline soft magnetic alloys were produced by heat-treating the obtained wound magnetic cores in a nitrogen atmosphere under the heat treatment conditions shown in Table 1.

### Comparative Example 18

A wound magnetic core was obtained in the same manner as in Example 1, except that a molten metal having the composition shown in Table 1 was used. A core of an Fe-based nanocrystalline soft magnetic alloy was produced by heat-treating the obtained wound magnetic core at 545° C. for 60 min in a nitrogen atmosphere, and a magnetic field with a magnetic field strength of 120 kA/m was applied to the wound magnetic core from after 50 min after the start of the heat treatment until the end of the heat treatment in the height direction of the wound magnetic core (that is, in the width direction of the ribbon constituting the wound magnetic core).

### Examples 38 to 47 and Comparative Examples 19 to 20

Wound magnetic cores were obtained in the same manner as in Example 1, except that molten metals having the compositions shown in Table 1 were used. Cores of Fe-based nanocrystalline soft magnetic alloys were produced by heat-treating the obtained wound magnetic cores in a nitrogen atmosphere under heat treatment conditions shown in Table 1, and a magnetic field with a magnetic field strength of 240 kA/m was applied to the wound magnetic cores in the height direction of the wound magnetic core (that is, in the width direction of the ribbon constituting the wound magnetic core) over the entire time of holding at a holding temperature shown in Table 1.

[Evaluation of Relative Magnetic Permeability]

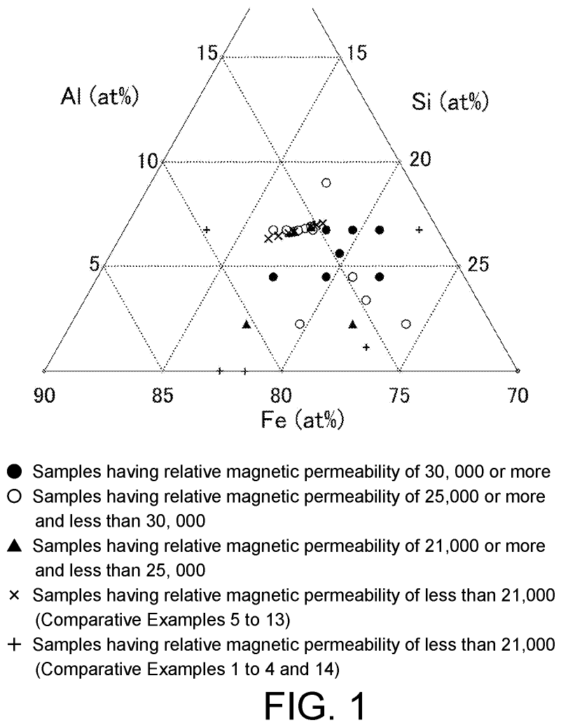

After the cores of Examples 1 to 47 and Comparative Examples 1 to 20 were loaded in respective resin cases, coils were produced by winding a copper wire with a wire diameter of 0.5 mm three turns around each resin case. Using an impedance analyzer (manufactured by Keysight Technologies, E4990A), the inductance of the obtained coils was measured at a frequency of 1 kHz or 100 kHz and Hm=0.4 A/m or less. The relative magnetic permeability of the Fe-based nanocrystalline soft magnetic alloys was obtained on the basis of the formula (1). The magnetic path length 1 is 39 mm, the effective cross-sectional area A is 1.8 mm², and the number of turns N is 3. The results are shown in Table 1 and FIG. 1.

TABLE 1

| | | | | | | | | | | relative |
|---|---|---|---|---|---|---|---|---|---|---|
| | ratio of each element | | | | | | three element ratio*¹ | | | magnetic |
| | [at %] | | | | | | [at %] | | | permeability |
| | Fe | Si | Al | Nb | B | Cu | Fe | Si | Al | 100 kHz |
| Comparative | 73.5 | 15.5 | 0 | 3.0 | 7.0 | 1.0 | 82.58 | 17.42 | 0 | 20,000 |
| Example 1 | | | | | | | | | | |
| Comparative | 67.5 | 20.5 | 1.0 | 3.0 | 7.0 | 1.0 | 75.84 | 23.03 | 1.12 | 20,000 |
| Example 2 | | | | | | | | | | |
| Example 1 | 71.5 | 15.5 | 2.0 | 3.0 | 7.0 | 1.0 | 80.34 | 17.42 | 2.25 | 24,000 |
| Example 2 | 69.5 | 17.5 | 2.0 | 3.0 | 7.0 | 1.0 | 78.09 | 19.66 | 2.25 | 28,000 |
| Example 3 | 67.5 | 19.5 | 2.0 | 3.0 | 7.0 | 1.0 | 75.84 | 21.91 | 2.25 | 22,000 |
| Example 4 | 65.5 | 21.5 | 2.0 | 3.0 | 7.0 | 1.0 | 73.60 | 24.16 | 2.25 | 29,000 |
| Example 5 | 66.5 | 19.5 | 3.0 | 3.0 | 7.0 | 1.0 | 74.72 | 21.91 | 3.37 | 27,000 |
| Example 6 | 69.5 | 15.5 | 4.0 | 3.0 | 7.0 | 1.0 | 78.09 | 17.42 | 4.49 | 33,000 |
| Example 7 | 67.5 | 17.5 | 4.0 | 3.0 | 7.0 | 1.0 | 75.84 | 19.66 | 4.49 | 34,000 |
| Example 8 | 66.5 | 18.5 | 4.0 | 3.0 | 7.0 | 1.0 | 74.72 | 20.79 | 4.49 | 25,000 |
| Example 9 | 65.5 | 19.5 | 4.0 | 3.0 | 7.0 | 1.0 | 73.60 | 21.91 | 4.49 | 32,000 |
| Example 10 | 66.5 | 17.5 | 5.0 | 3.0 | 7.0 | 1.0 | 74.72 | 19.66 | 5.62 | 34,000 |
| Example 11 | 67.5 | 15.5 | 6.0 | 3.0 | 7.0 | 1.0 | 75.84 | 17.42 | 6.74 | 37,000 |
| Example 12 | 65.5 | 15.5 | 8.0 | 3.0 | 7.0 | 1.0 | 73.60 | 17.42 | 8.99 | 26,000 |
| Comparative | 71.0 | 12.0 | 6.0 | 3.0 | 7.0 | 1.0 | 79.78 | 13.48 | 6.74 | 14,000 |
| Example 3 | | | | | | | | | | |
| Example 13 | 68.5 | 14.5 | 6.0 | 3.0 | 7.0 | 1.0 | 76.97 | 16.29 | 6.74 | 25,000 |
| Example 14 | 68.0 | 15.0 | 6.0 | 3.0 | 7.0 | 1.0 | 76.40 | 16.85 | 6.74 | 28,000 |
| Example 15 | 67.0 | 16.0 | 6.0 | 3.0 | 7.0 | 1.0 | 75.28 | 17.98 | 6.74 | 29,000 |
| Example 16 | 66.5 | 16.5 | 6.0 | 3.0 | 7.0 | 1.0 | 74.72 | 18.54 | 6.74 | 37,000 |
| Example 17 | 65.5 | 17.5 | 6.0 | 3.0 | 7.0 | 1.0 | 73.60 | 19.66 | 6.74 | 35,000 |
| Example 18 | 64.5 | 18.5 | 6.0 | 3.0 | 7.0 | 1.0 | 72.47 | 20.79 | 6.74 | 31,000 |
| Comparative | 63.0 | 20.0 | 6.0 | 3.0 | 7.0 | 1.0 | 70.79 | 22.47 | 6.74 | 10,000 |
| Example 4 | | | | | | | | | | |
| Comparative | 69.5 | 15.5 | 6.0 | 1.0 | 7.0 | 1.0 | 76.37 | 17.03 | 6.59 | 9,000 |
| Example 5 | | | | | | | | | | |
| Example 19 | 68.5 | 15.5 | 6.0 | 2.0 | 7.0 | 1.0 | 76.11 | 17.22 | 6.67 | 21,000 |
| Example 20 | 66.5 | 15.5 | 6.0 | 4.0 | 7.0 | 1.0 | 75.57 | 17.61 | 6.82 | 32,000 |
| Example 21 | 65.5 | 15.5 | 6.0 | 5.0 | 7.0 | 1.0 | 75.29 | 17.82 | 6.90 | 21,000 |
| Comparative | 64.5 | 15.5 | 6.0 | 6.0 | 7.0 | 1.0 | 75.00 | 18.02 | 6.98 | 3,500 |
| Example 6 | | | | | | | | | | |
| Comparative | 73.5 | 15.5 | 6.0 | 3.0 | 1.0 | 1.0 | 77.37 | 16.32 | 6.32 | —*² |
| Example 7 | | | | | | | | | | |
| Comparative | 71.5 | 15.5 | 6.0 | 3.0 | 3.0 | 1.0 | 75.88 | 16.67 | 6.45 | —*² |
| Example 8 | | | | | | | | | | |
| Example 22 | 69.5 | 15.5 | 6.0 | 3.0 | 5.0 | 1.0 | 76.37 | 17.03 | 6.59 | 31,000 |
| Example 23 | 68.5 | 15.5 | 6.0 | 3.0 | 6.0 | 1.0 | 76.11 | 17.22 | 6.67 | 27,000 |
| Example 24 | 66.5 | 15.5 | 6.0 | 3.0 | 8.0 | 1.0 | 75.57 | 17.61 | 6.82 | 25,000 |
| Example 25 | 65.5 | 15.5 | 6.0 | 3.0 | 9.0 | 1.0 | 75.29 | 17.82 | 6.90 | 29,000 |
| Comparative | 64.5 | 15.5 | 6.0 | 3.0 | 10.0 | 1.0 | 75.00 | 18.02 | 6.98 | —*² |
| Example 9 | | | | | | | | | | |
| Comparative | 63.5 | 15.5 | 6.0 | 3.0 | 11.0 | 1.0 | 74.71 | 18.24 | 7.06 | —*² |
| Example 10 | | | | | | | | | | |
| Comparative | 68.5 | 15.5 | 6.0 | 3.0 | 7.0 | 0.0 | 76.11 | 17.22 | 6.67 | 10,000 |
| Example 11 | | | | | | | | | | |
| Example 26 | 68.0 | 15.5 | 6.0 | 3.0 | 7.0 | 0.5 | 75.98 | 17.32 | 6.70 | 26,000 |
| Example 27 | 67.8 | 15.5 | 6.0 | 3.0 | 7.0 | 0.7 | 75.92 | 17.36 | 6.72 | 28,000 |
| Comparative | 65.5 | 15.5 | 6.0 | 3.0 | 7.0 | 3.0 | 75.29 | 17.82 | 6.90 | 14,000 |
| Example 12 | | | | | | | | | | |
| Comparative | 63.5 | 15.5 | 6.0 | 3.0 | 7.0 | 5.0 | 74.71 | 18.24 | 7.06 | —*² |
| Example 13 | | | | | | | | | | |
| Comparative | 73.5 | 16.5 | 0 | 3.0 | 6.0 | 1.0 | 81.67 | 18.33 | 0 | 18,000 |
| Example 14 | | | | | | | | | | |

*¹content ratio of Fe, Si and Al in the alloy composition (i.e., 1-x-y, x and y multiplied by 100, respectively), when the sum of the
total content of Fe, Si and Al is taken as 100 at. %.
*²an amorphous alloy ribbon was not obtained.

| | | | | | | | | | | heat treatment | | | |
|---|---|---|---|---|---|---|---|---|---|---|---|---|---|
| | | | | | | | | | | condition | | relative | |
| | ratio of each element | | | | | | three element ratio*¹ | | | holding | holding | magnetic | |
| | [at %] | | | | | | [at %] | | | temperature | time | permeability | |
| | Fe | Si | Al | Nb | B | Cu | Fe | Si | Al | [° C.] | [min] | 1 kHz | 100 kHz |
| Comparative | 73.5 | 16.5 | 0.0 | 3.0 | 6.0 | 1.0 | 82.6 | 18.5 | 0.0 | 545 | 60 | 69,000 | 19,000 |
| Example 15 | | | | | | | | | | | | | |
| Example 28 | 67.5 | 20.5 | 1.0 | 3.0 | 7.0 | 1.0 | 75.8 | 23.0 | 1.1 | 535 | 10 | 51,000 | 23,000 |
| Example 29 | 67.5 | 19.5 | 2.0 | 3.0 | 7.0 | 1.0 | 75.8 | 21.9 | 2.2 | 545 | 10 | 46,000 | 23,000 |
| Example 30 | 65.5 | 21.5 | 2.0 | 3.0 | 7.0 | 1.0 | 73.6 | 24.2 | 2.2 | 545 | 10 | 58,000 | 30,000 |
| Example 31 | 67.5 | 18.5 | 3.0 | 3.0 | 7.0 | 1.0 | 75.8 | 20.8 | 3.4 | 545 | 10 | 63,000 | 24,000 |
| Example 32 | 66.5 | 19.5 | 3.0 | 3.0 | 7.0 | 1.0 | 74.7 | 21.9 | 3.4 | 545 | 10 | 83,000 | 30,000 |
| Example 33 | 67.5 | 17.5 | 4.0 | 3.0 | 7.0 | 1.0 | 75.8 | 19.7 | 4.5 | 545 | 10 | 71,000 | 35,000 |
| Example 34 | 67.5 | 16.5 | 5.0 | 3.0 | 7.0 | 1.0 | 75.8 | 18.5 | 5.6 | 555 | 10 | 55,000 | 25,000 |
| Example 35 | 67.5 | 15.5 | 6.0 | 3.0 | 7.0 | 1.0 | 75.8 | 17.4 | 6.7 | 575 | 10 | 70,000 | 39,000 |
| Comparative | 71.0 | 12.0 | 6.0 | 3.0 | 7.0 | 1.0 | 79.8 | 13.5 | 6.7 | 605 | 10 | 41,000 | 21,000 |
| Example 16 | | | | | | | | | | | | | |
| Comparative | 63.0 | 20.0 | 6.0 | 3.0 | 7.0 | 1.0 | 70.8 | 22.5 | 6.7 | 535 | 10 | 7,700 | 7,100 |
| Example 17 | | | | | | | | | | | | | |
| Example 36 | 67.5 | 15.0 | 6.5 | 3.0 | 7.0 | 1.0 | 75.8 | 16.9 | 7.3 | 585 | 10 | 59,000 | 32,000 |
| Example 37 | 67.5 | 14.5 | 7.0 | 3.0 | 7.0 | 1.0 | 75.8 | 16.3 | 7.9 | 605 | 10 | 77,000 | 30,000 |
| Comparative | 73.5 | 16.5 | 0.0 | 3.0 | 6.0 | 1.0 | 82.6 | 18.5 | 0.0 | 545 | 60 | 49,000 | 24,000 |
| Example 18 | | | | | | | | | | | | | |
| Example 38 | 67.5 | 20.5 | 1.0 | 3.0 | 7.0 | 1.0 | 75.0 | 23.0 | 1.1 | 535 | 10 | 51,000 | 34,000 |
| Example 39 | 67.5 | 19.5 | 2.0 | 3.0 | 7.0 | 1.0 | 75.8 | 21.9 | 2.2 | 545 | 10 | 50,000 | 34,000 |
| Example 40 | 65.5 | 21.5 | 2.0 | 3.0 | 7.0 | 1.0 | 73.6 | 24.2 | 2.2 | 545 | 10 | 46,000 | 37,000 |
| Example 41 | 67.5 | 18.5 | 3.0 | 3.0 | 7.0 | 1.0 | 75.8 | 20.8 | 3.4 | 545 | 10 | 63,000 | 36,000 |
| Example 42 | 66.5 | 19.5 | 3.0 | 3.0 | 7.0 | 1.0 | 74.7 | 21.9 | 3.4 | 545 | 10 | 65,000 | 40,000 |
| Example 43 | 67.5 | 17.5 | 4.0 | 3.0 | 7.0 | 1.0 | 75.8 | 19.7 | 4.5 | 545 | 10 | 71,000 | 52,000 |
| Example 44 | 67.5 | 16.5 | 5.0 | 3.0 | 7.0 | 1.0 | 75.8 | 18.5 | 5.6 | 555 | 10 | 110,000 | 49,000 |
| Example 45 | 67.5 | 15.5 | 6.0 | 3.0 | 7.0 | 1.0 | 75.8 | 17.4 | 6.7 | 575 | 10 | 90,000 | 54,000 |
| Comparative | 71.0 | 12.0 | 6.0 | 3.0 | 7.0 | 1.0 | 79.8 | 13.5 | 6.7 | 605 | 10 | 21,000 | 16,000 |
| Example 19 | | | | | | | | | | | | | |
| Comparative | 63.0 | 20.0 | 6.0 | 3.0 | 7.0 | 1.0 | 70.8 | 22.5 | 6.7 | 535 | 10 | 6,000 | 5,800 |
| Example 20 | | | | | | | | | | | | | |
| Example 46 | 67.5 | 15.0 | 6.5 | 3.0 | 7.0 | 1.0 | 75.8 | 16.9 | 7.3 | 585 | 10 | 87,000 | 52,000 |
| Example 47 | 67.5 | 14.5 | 7.0 | 3.0 | 7.0 | 1.0 | 75.8 | 16.3 | 7.9 | 605 | 10 | 91,000 | 45,000 |

*¹content ratio of Fe, Si and Al in the alloy composition, when the sum of the total content of Fe, Si and Al is taken as 100 at. %.

Table 1 and FIG. 1 show that the Fe-based nanocrystalline soft magnetic alloys of Examples 1 to 27 and 29 to 37 having the compositions represented by the general formula (I) had a high relative magnetic permeability of 21,000 or more at a frequency of 100 kHz. Further, from Examples 38 to 47, it was confirmed that by applying a magnetic field during the heat treatment, it is possible to achieve a relative magnetic permeability higher than that when no magnetic field is applied.

Meanwhile, Fe-based nanocrystalline soft magnetic alloys of Comparative Examples 5 to 13, in which the content ratio of Fe, Si and Al was within the range of general formula (I), but the amounts of Nb, B and Cu were outside the range of general formula (I), had a relative magnetic permeability of 20,000 or less at a frequency of 100 kHz (indicated by “x” in FIG. 1).

From this, it can be said that in order for the Fe-based nanocrystalline soft magnetic alloy to exhibit a high relative magnetic permeability, it is important to satisfy not only the conditions related to x and y in the general formula (I) but also all the conditions related to a, b, and c.

In addition, Example 28 and Example 38, which differed only in production conditions, namely, the presence or absence of magnetic field application during the heat treatment, relate to the composition represented by the general formula (II) in which the content ratio of Al in the three element ratio of Fe, Si, and Al is lower than that in the composition represented by the general formula (I). The comparison of these examples shows that with the composition represented by the general formula (II), by applying a magnetic field during the heat treatment, the relative magnetic permeability at a frequency of 100 kHz is increased compared to the case where no magnetic field was applied, and a high relative magnetic permeability can be achieved.

Meanwhile, by comparing Comparative Examples 16 and 19 and Comparative Examples 17 and 20, it was found that where conditions for y, which is the content ratio of Al in the three element ratio of Fe, Si and Al in the composition represented by the general formula (I), are satisfied and the conditions for 1-x-y and x, which are the content ratios of Fe and Si in the three element ratio, are not satisfied, the relative magnetic permeability could not be improved even if a magnetic field was applied during heat treatment.

Further, from Table 1, it was found that where the alloy composition was represented by the general formula (I) or (II), the application of a magnetic field during the heat treatment tended to improve the relative magnetic permeability not only in a high-frequency region but also in a low-frequency region.

[Evaluation of Composition Distribution]

A ribbon was unwound from the core produced in Example 11 and processed to obtain a needle-like sample with a tip coefficient of about 10 nm. The distribution of Si, Al, B, and Cu was evaluated by structural observation using a three-dimensional atom probe for a range of about 30 nm×30 nm×70 nm of the obtained needle-like sample. The results are shown in FIG. 2.

FIG. 2 shows the concentration of each atom in light and dark. In other words, dark areas have low density, and bright areas have high density. In FIG. 2, the portion where Si is distributed in large quantities is a crystal grain, and the portion where B is distributed in large quantities is an amorphous phase.

From FIG. 2, it was confirmed that in the Fe-based nanocrystalline soft magnetic alloy of Example 11, clusters are dispersed in the amorphous phase. Since the distribution of Cu clusters and the distribution of Al clusters were observed at almost the same position, each cluster is considered to be an aggregate including both Cu and Al.

In addition, from FIG. 2, it was confirmed that Al is present as clusters in the amorphous phase and is also distributed in large quantities in crystal grains.

[Evaluation I of Crystal Grain Size]

Ribbons were unwound from the cores prepared in Examples 6, 11, 12, 39, and 43 to 46, and Comparative Example 14, analysis using an X-ray diffractometer (XRD) was performed, and the average crystal grain size of the crystal grains was obtained by averaging according to the formula (3). Table 2 shows the results.

TABLE 2

| | | | | | | | | | | relative | average |
|---|---|---|---|---|---|---|---|---|---|---|---|
| | ratio of each element | | | | | | three element ratio*¹ | | | magnetic | crystal |
| | [at %] | | | | | | [at %] | | | permeability | size |
| | Fe | Si | Al | Nb | B | Cu | Fe | Si | Al | 100 kHz | [mm] |
| Example 6 | 69.5 | 15.5 | 4.0 | 3.0 | 7.0 | 1.0 | 78.09 | 17.42 | 4.49 | 33,000 | 10.52 |
| Example 11 | 67.5 | 15.5 | 6.0 | 3.0 | 7.0 | 1.0 | 75.84 | 17.42 | 6.74 | 37,000 | 10.72 |
| Example 12 | 65.5 | 15.5 | 8.0 | 3.0 | 7.0 | 1.0 | 73.60 | 17.42 | 8.99 | 26,000 | 10.54 |
| Comparative | 67.5 | 19.5 | 2.0 | 3.0 | 7.0 | 1.0 | 75.8 | 21.9 | 2.2 | 34,000 | 10.90 |
| Example 39 | | | | | | | | | | | |
| Example 41 | 67.5 | 18.5 | 3.0 | 3.0 | 7.0 | 1.0 | 75.8 | 20.8 | 3.4 | 36,000 | 11.11 |
| Example 43 | 67.5 | 17.5 | 4.0 | 3.0 | 7.0 | 1.0 | 75.8 | 19.7 | 4.5 | 52,000 | 10.80 |
| Example 44 | 67.5 | 16.5 | 5.0 | 3.0 | 7.0 | 1.0 | 75.8 | 18.5 | 5.6 | 49,000 | 9.11 |
| Example 45 | 67.5 | 15.5 | 6.0 | 3.0 | 7.0 | 1.0 | 75.8 | 17.4 | 6.7 | 54,000 | 9.92 |
| Example 46 | 67.5 | 15.0 | 6.5 | 3.0 | 7.0 | 1.0 | 75.8 | 16.9 | 7.3 | 52,000 | 9.77 |
| Example 14 | 73.5 | 16.5 | 0 | 3.0 | 6.0 | 1.0 | 81.67 | 18.33 | 0 | 18,000 | 12.17 |

*¹content ratio of Fe, Si and Al in the alloy composition, when the sum of the total content of Fe, Si and Al is taken as 100 at. %.

As shown in Table 2, the alloy of Comparative Example 14, which did not contain Al in the composition, had an average crystal grain size of the crystal grains of more than 12.0 nm, while the Fe-based nanocrystalline soft magnetic alloys of Examples 6, 11, 12, 39, and 43 to 46 having the composition represented by the general formula (I) had an average crystal grain size of the crystal grains of 11.3 nm or less. Thus, in the alloy having the composition represented by the general formula (I), the crystal grain size is refined.

It is considered that in the Fe-based nanocrystalline soft magnetic alloy having the composition represented by the general formula (I), crystal growth was suppressed and crystal grains with a smaller average grain size than in an alloy including no Al in the composition were formed because Cu and Al clusters were formed and the distance between the clusters was narrowed.

[Evaluation II of Composition Distribution]

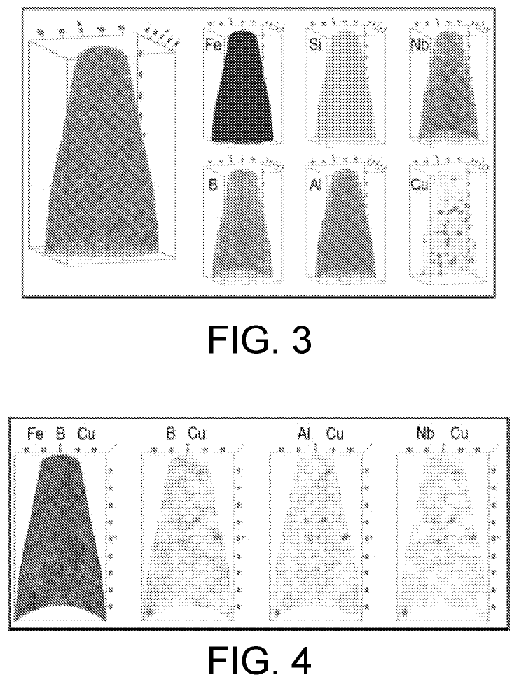

Ribbons were unwound from the cores produced in Example 11 and Comparative Example 14 and processed to obtain needle-like samples with a tip coefficient of about 10 nm. The distribution of Fe, Si, Al, Nb, B, and Cu was evaluated by structural observation using a three-dimensional atom probe (manufactured by CAMECA, EIKOS-UV) for a range of about 30 nm×30 nm×70 nm of the obtained needle-like sample. The results are shown in Table 3. A three-dimensional map of the Fe-based nanocrystalline soft magnetic alloy obtained in Example 11 is shown in FIG. 3, and a sliced three-dimensional map is shown in FIG. 4.

TABLE 3

| | ratio of each element | | | | | | three element ratio | | | measured | number of | number density |
|---|---|---|---|---|---|---|---|---|---|---|---|---|
| | [at %] | | | | | | [at %] | | | volume | clusters | of clusters |
| | Fe | Si | Al | Nb | B | Cu | Fe | Si | Al | [nm³] | [nm⁻³] | [10⁻⁴/nm³] |
| Example 11 | 67.5 | 15.5 | 6.0 | 3.0 | 7.0 | 1.0 | 75.84 | 17.42 | 6.74 | 115660 | 33*¹ | 2.9*¹ |
| Comparative | 73.5 | 16.5 | 0 | 3.0 | 6.0 | 1.0 | 81.67 | 18.33 | 0 | 290000 | 40*² | 1.4*² |
| Example 14 | | | | | | | | | | | | |

*¹a cluster having a total content of Cu and Al of 20 at. % or more is counted as one cluster.
*²a cluster having Cu content of 20 at. % or more is counted as one cluster.

From Table 3, FIG. 3, and FIG. 4, it was found that the Fe-based nanocrystalline soft magnetic alloy of Example 11 had a smaller average cluster size and a higher cluster number density than the alloy of Comparative Example 14. Further, as can be seen from Table 2, the Fe-based nanocrystalline soft magnetic alloy of Example 11 has a smaller average crystal grain size and a higher relative magnetic permeability than the alloy of Comparative Example 14. From the above, it is understood that the Fe-based nanocrystalline soft magnetic alloy in which small-sized clusters are present at a sufficient number density has a small average crystal grain size of the crystal grains and a high relative magnetic permeability.

[Evaluation of Number of Magnetic Domain Walls]

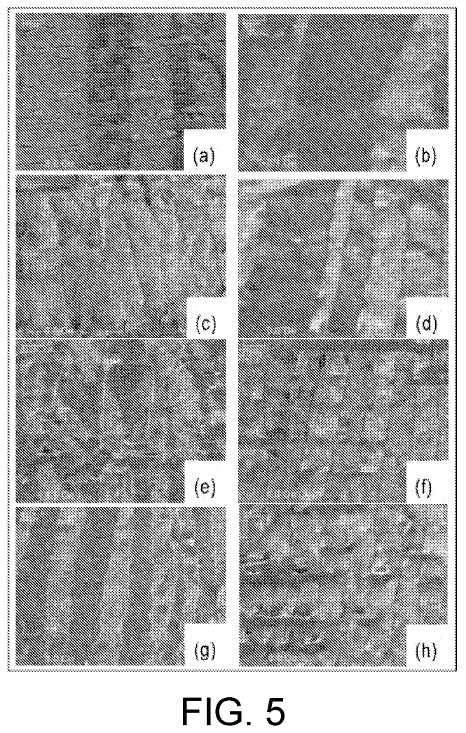

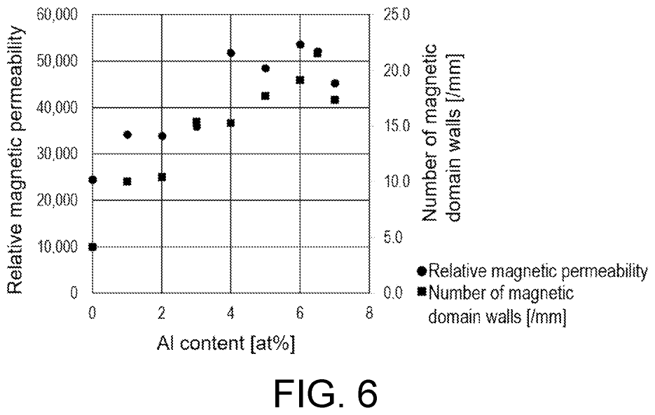

Observation of the magnetic domain structures of the Fe-based nanocrystalline soft magnetic alloys obtained in Comparative Example 18 and Examples 38, 39, 41 and 43 to 47 was performed with a polarizing microscope using the magnetic Kerr effect (magnetic domain observation device manufactured by Neoark Corporation, BH-782PI-NCC). Polarizing microscope micrographs of the magnetic domain structures of the Fe-based nanocrystalline soft magnetic alloys of Comparative Example 18 and Examples 38, 39, 41, 44, 45, 46 and 47 are shown in FIGS. 5(a) to 5(h), respectively. In addition, the number of magnetic domain walls per arbitrary 1 mm in the polarizing microscope micrograph was measured at 5 points to 10 points, and the average value was obtained as the number of magnetic domain walls. Table 4 shows the results. FIG. 6 shows the relationship between the Al content ratio, the number of magnetic domain walls, and the relative magnetic permeability.

TABLE 4

| | | | | | | | | | | | number of |
|---|---|---|---|---|---|---|---|---|---|---|---|
| | | | | | | | three element | | | relative | magnetic |
| | ratio of each element | | | | | | ratio*¹ | | | magnetic | domain |
| | [at %] | | | | | | [at %] | | | permeability | walls |
| | Fe | Si | Al | Nb | B | Cu | Fe | Si | Al | 100 kHz | [nm⁻¹] |
| Comparative | 73.5 | 16.5 | 0.0 | 3.0 | 6.0 | 1.0 | 82.6 | 18.5 | 0.0 | 24,000 | 4.2 |
| Example 18 | | | | | | | | | | | |
| Example 38 | 67.5 | 20.5 | 1.0 | 3.0 | 7.0 | 1.0 | 75.8 | 23.0 | 1.1 | 34,000 | 10.0 |
| Example 39 | 67.5 | 19.5 | 2.0 | 3.0 | 7.0 | 1.0 | 75.8 | 21.9 | 2.2 | 34,000 | 10.4 |
| Example 41 | 67.5 | 18.5 | 3.0 | 3.0 | 7.0 | 1.0 | 75.8 | 20.8 | 3.4 | 36,000 | 15.4 |
| Example 43 | 67.5 | 17.5 | 4.0 | 3.0 | 7.0 | 1.0 | 75.8 | 19.7 | 4.5 | 52,000 | 15.3 |
| Example 44 | 67.5 | 16.5 | 5.0 | 3.0 | 7.0 | 1.0 | 75.8 | 18.5 | 5.6 | 49,000 | 17.7 |
| Example 45 | 67.5 | 15.5 | 6.0 | 3.0 | 7.0 | 1.0 | 75.8 | 17.4 | 6.7 | 54,000 | 19.2 |
| Example 46 | 67.5 | 15.0 | 6.5 | 3.0 | 7.0 | 1.0 | 75.8 | 16.9 | 7.3 | 52,000 | 21.5 |
| Example 47 | 67.5 | 14.5 | 7.0 | 3.0 | 7.0 | 1.0 | 75.8 | 16.3 | 7.9 | 45,000 | 17.4 |

*¹content ratio of Fe, Si and Al in the alloy composition, when the sum of the total content of Fe, Si and Al is taken as 100 at. %.

From Table 4 and FIG. 6, the Fe-based nanocrystalline soft magnetic alloy containing no Al (Comparative Example 18) had a number of magnetic domain walls of 4.2/mm, whereas the Fe-based nanocrystalline soft magnetic alloys with y in the general formula (I) within the range of 0.012 or more and 0.100 or less (Examples 38, 39, 41, and 43 to 47) had a number of magnetic domain walls of 10/mm or more. Further, when y in general formula (I) was in the range of 0.040 or more and 0.100 or less (Examples 43 to 47), the number of magnetic domain walls was 15/mm or more, that is, even larger. Further, from FIG. 6, it was confirmed that the relationship between the Al content ratio and the number of magnetic domain walls behaves similarly to the relationship between the Al content ratio and the relative magnetic permeability. Therefore, from FIG. 6, it is considered that there is a relationship between the number of magnetic domain walls and the relative magnetic permeability, and that the relative magnetic permeability improves as the number of magnetic domain walls increases.

From these results, it was found that having the composition represented by the general formula (I) increases the number of magnetic domain walls and also improves the relative magnetic permeability. It was also found that the magnetic domain walls can be subdivided by adjusting the Al content ratio.

### Examples 48 to 59 and Comparative Examples 21 to 29

Cores were produced in the same manner as in Example 1, except that the composition of the molten metal, the heat treatment temperature, and the heat treatment time were changed as shown in Table 5, and the relative magnetic permeability was calculated. In addition, magnetostriction was measured according to the following measurement method. Table 5 shows the results.

The molten metal composition used in Comparative Examples 24 to 29 is the same as that of the conventional soft magnetic material described in patent document 1.

[Method for Measuring Magnetostriction]

Where an external force is applied to expand and contract a metal (resistor), the resistance value increases or decreases. The strain gauge method utilizes this. A strain gauge was adhesively bonded to the ribbon unwound from the core through an electrical insulating polyimide film, and magnetostriction was determined by measuring the relative strain with the strain gauge at the time of magnetization to magnetic saturation in a solenoid magnet.

TABLE 5

| | ratio of each element | | | | | | heat treatment | heat treatment | relative | |
|---|---|---|---|---|---|---|---|---|---|---|
| | [at %] | | | | | | temperature | time | magnetic | magnetostriction |
| | Fe | Si | Al | Nb | B | Cu | [° C.] | [min] | permeability | [ppm] |
| Comparative | 67.5 | 15.5 | 6.0 | 3.0 | 17.0 | 1.0 | — | — | 2,000 | 15 |
| Example 21 | | | | | | | | | | |
| Example 48 | | | | | | | 560 | 10 | 26,000 | 2.5 |
| Example 49 | | | | | | | 570 | 10 | 31,000 | 1 |
| Example 50 | | | | | | | 580 | 10 | 31,000 | 0.5 |
| Example 51 | | | | | | | 590 | 10 | 28,000 | 0 |
| Comparative | 66.5 | 16.5 | 6.0 | 3.0 | 7.0 | 1.0 | — | — | 2,000 | 10 |
| Example 22 | | | | | | | | | | |
| Example 52 | | | | | | | 550 | 10 | 31,000 | 1 |
| Example 53 | | | | | | | 560 | 10 | 36,000 | 1 |
| Example 54 | | | | | | | 570 | 10 | 35,000 | −1 |
| Example 55 | | | | | | | 580 | 10 | 31,000 | −1 |
| Comparative | 65.5 | 17.5 | 6.0 | 3.0 | 7.0 | 1.0 | — | — | 2,000 | 16 |
| Example 23 | | | | | | | | | | |
| Example 56 | | | | | | | 530 | 10 | 26,000 | 2 |
| Example 57 | | | | | | | 540 | 10 | 33,000 | 0 |
| Example 58 | | | | | | | 550 | 10 | 33,000 | 0 |
| Example 59 | | | | | | | 560 | 10 | 31,000 | 0 |
| Comparative | 73.5 | 16.5 | 0 | 3.0 | 6.0 | 1.0 | 520 | 10 | 6,000 | 3 |
| Example 24 | | | | | | | | | | |
| Comparative | | | | | | | 520 | 60 | 16,000 | 1 |
| Example 25 | | | | | | | | | | |
| Comparative | | | | | | | 520 | 420 | 17,000 | 4 |
| Example 26 | | | | | | | | | | |
| Comparative | | | | | | | 550 | 10 | 19,000 | 1.5 |
| Example 27 | | | | | | | | | | |
| Comparative | | | | | | | 550 | 60 | 18,000 | 1 |
| Example 28 | | | | | | | | | | |
| Comparative | | | | | | | 550 | 420 | 16,000 | 1 |
| Example 29 | | | | | | | | | | |

Table 5 shows that by heat-treating the amorphous alloy obtained from the molten metal having the composition represented by the general formula (I) at 530° C. to 590° C. for 10 min, it is possible to obtain an Fe-based nanocrystalline soft magnetic alloy with a magnetostriction near zero and a high relative magnetic permeability of 26,000 or more at a frequency of 100 kHz.

Meanwhile, when the heat treatment was not performed (Comparative Examples 15 to 17), the relative magnetic permeability had a very low value of 2000. With the alloys (Comparative Examples 18 to 23) that did not satisfy the composition represented by the general formula (I), it was found that Fe-based nanocrystalline soft magnetic alloys exhibiting a relative magnetic permeability of 20,000 or more could not be obtained when the heat treatment was performed at a temperature of 520° C. or 550° C., which is the same as in Examples 28 to 39, even when the heat treatment time was extended.

[Evaluation of Magnetocrystalline Anisotropy]

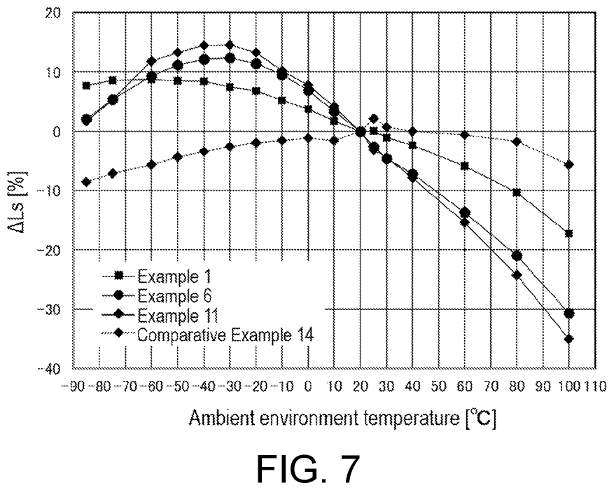

Coils were produced by loading the cores produced in Examples 1, 6, and 11 and Comparative Example 14 in respective resin cases and winding three turns of a copper wire with a wire diameter of 0.5 mm around each resin case. Using an impedance analyzer (manufactured by Keysight Technologies, E4990A), the inductance Ls of the obtained coils was measured at a frequency of 1 kHz and Hm=0.4 A/m or less under different ambient environment temperatures. Table 6 shows the results. Also, the change rate ALs of the inductance Ls at each ambient environment temperature was calculated using the inductance Ls at the normal ambient environment temperature (20° C.) as a reference. FIG. 7 shows the relationship between the ambient environment temperature and the inductance change rate ALs (%).

TABLE 6

| | | | Comparative | | | |
|---|---|---|---|---|---|---|
| | | | Example 14 | Example 1 | Example 6 | Example 11 |
| Ls | 100° | C. | 86.3 | 68.44 | 78.3 | 86.2 |
| [μH] | 80° | C. | 89.9 | 74.15 | 89.2 | 100.4 |
| | 60° | C. | 91.0 | 77.83 | 97.5 | 112.2 |
| | 40° | C. | 91.5 | 80.78 | 104.8 | 122.1 |
| | 30° | C. | 92.1 | 81.80 | 107.7 | 126.7 |
| | 25° | C. | 93.5 | 82.72 | 110.0 | 128.4 |
| | 20° | C. | 91.5 | 82.70 | 112.9 | 132.6 |
| | 10° | C. | 90.1 | 84.15 | 116.7 | 138.1 |
| | 0 | | 90.4 | 85.80 | 120.7 | 142.9 |
| | −10° | C. | 90.1 | 87.00 | 123.7 | 146.1 |
| | −20° | C. | 89.7 | 88.34 | 125.8 | 150.2 |
| | −30° | C. | 89.1 | 88.90 | 126.9 | 151.9 |
| | −40° | C. | 88.4 | 89.67 | 126.6 | 151.8 |
| | −50° | C. | 87.5 | 89.75 | 125.5 | 150.2 |
| | −60° | C. | 86.3 | 89.91 | 123.4 | 148.3 |
| | −75° | C. | 85.0 | 89.79 | 119.0 | 139.6 |
| | −85° | C. | 83.7 | 89.07 | 115.2 | 134.8 |

In Comparative Example 14, which does not contain Al, the amount of change in the inductance Ls with respect to the value of the inductance Ls at the normal temperature of 20° C. tends to decrease as the ambient environment temperature decreases, but it is recognized that there is no maximum point. From the formula (1), the higher the inductance change rate, the higher the relative magnetic permeability. That is, from FIG. 7, the relative magnetic permeability is recognized to depend on temperature, and the inductance shows a maximum point at a specific ambient environment temperature. Further, from the results obtained in Examples 1, 6 and 11, it is recognized that in compositions with different Al contents, the temperature at which the maximum point is obtained shifts to the low temperature side as the Al concentration decreases.

Here, FIG. 3 in Ken Takahashi, Hideo Arai, Toshiro Tanaka, Tokuo Wakiyama, “Regular Structure and Magnetocrystalline Anisotropy of Sendust Alloy Single Crystal”, Journal of Magnetics Society of Japan, 1986, Vol. 10, No. 2, p. 221-224 (hereinafter referred to as “Reference Document”) clearly shows that the magnetocrystalline anisotropy K depends on temperature, and that when the temperature is lowered, the positive magnetocrystalline anisotropy K decreases to zero and then assumes a negative value. In general, it is expected that the magnetic permeability will be maximized when the magnetocrystalline anisotropy K becomes zero. That is, when the temperature is lowered from normal temperature, K becomes positive at a certain temperature or higher temperature, and after K becomes zero at that temperature, the magnetocrystalline anisotropy K becomes negative when the temperature is further lowered. That is, since K≠0 at temperatures other than that temperature, the relative magnetic permeability decreases. It can be seen that the relative magnetic permeability at that temperature is higher than around that temperature. Further, in the Reference Document, it is shown that the temperature (K=0) at which the magnetocrystalline anisotropy K becomes zero shifts to the low temperature side as the Al concentration decreases and the magnetocrystalline anisotropy K at normal temperature increases.

Based on FIG. 7 and FIG. 3 of the Reference Document, it can be said that the change tendency of the ambient environment temperature at which the inductance, which changes with the difference in the amount of Al added in Examples 1, 6, and 11, shows the maximum point and the change tendency of the temperature at which the magnetocrystalline anisotropy K in the Reference Document is zero substantially match each other. From this, it can be said that the magnetocrystalline anisotropy K of the Fe—Si—Al ternary system alloy and the relative magnetic permeability of the Fe-based nanocrystalline soft magnetic alloys obtained in the Examples are recognized to have similar temperature dependencies, and it is shown that in the Fe-based nanocrystalline soft magnetic alloys, the magnetocrystalline anisotropy K in the crystal grains also has a strong correlation with the relative magnetic permeability. Therefore, it is recognized that there is a relationship between setting the magnetocrystalline anisotropy K to zero and increasing the relative magnetic permeability. In addition, it can be inferred that by including Al, it is possible to realize the improvement of the relative magnetic permeability and a zero magnetocrystalline anisotropy K.

### Examples 60 to 71, Reference Examples 1 to 4, and Comparative Examples 30 to 33

Wound magnetic cores were obtained in the same manner as in Example 1, except that the molten metals having the compositions shown in Table 7 were used. Cores of the Fe-based nanocrystalline soft magnetic alloys were prepared by subjecting the obtained wound magnetic cores to heat treatment under the heat treatment conditions shown in Table 7 in a nitrogen atmosphere and applying a magnetic field with a magnetic field strength of 240 kA/m to the wound magnetic cores in the height direction of the wound cores (that is, in the width direction of the ribbons constituting the wound cores) over the entire time of holding at the holding temperature shown in Table 7.

[Evaluation II of Crystal Grain Size]

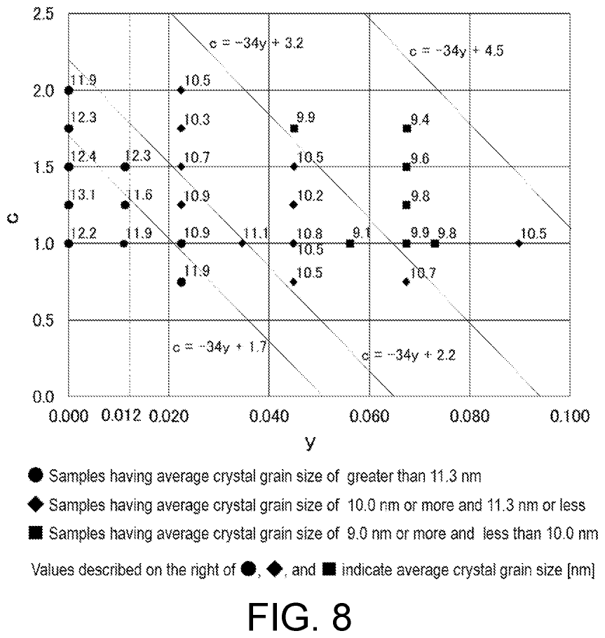

The average crystal grain size of the crystal grains was determined by unwinding ribbons from the cores prepared in Examples 6, 11, 12, 39, 41, 43 to 46, and 60 to 71, Reference Examples 1 to 4, and Comparative Examples 14 and 30 to 33, performing analysis by using an X-ray diffractometer (XRD), and averaging according to the formula (3). The results are shown in Table 7 and FIG. 8.

TABLE 7

| | | | | | | | | | | heat treatment | | |
|---|---|---|---|---|---|---|---|---|---|---|---|---|
| | | | | | | | | | | condition | | average |
| | ratio of each element | | | | | | three element ratio*¹ | | | holding | holding | crystal |
| | [at %] | | | | | | [at %] | | | temperature | time | grain size |
| | Fe | Si | Al | Nb | B | Cu | Fe | Si | Al | [° C.] | [min] | [nm] |
| Example 6 | 69.5 | 15.5 | 4.0 | 3.0 | 7.0 | 1.0 | 78.1 | 17.4 | 4.5 | 550 | 60 | 10.5 |
| Example 11 | 67.5 | 15.5 | 6.0 | 3.0 | 7.0 | 1.0 | 75.8 | 17.4 | 6.7 | 550 | 60 | 10.7 |
| Example 12 | 65.5 | 15.5 | 8.0 | 3.0 | 7.0 | 1.0 | 73.6 | 17.4 | 9.0 | 550 | 60 | 10.5 |
| Example 39 | 67.5 | 19.5 | 2.0 | 3.0 | 7.0 | 1.0 | 75.8 | 21.9 | 2.2 | 545 | 10 | 10.9 |
| Example 41 | 67.5 | 18.5 | 3.0 | 3.0 | 7.0 | 1.0 | 75.8 | 20.8 | 3.4 | 545 | 10 | 11.1 |
| Example 43 | 67.5 | 17.5 | 4.0 | 3.0 | 7.0 | 1.0 | 75.8 | 19.7 | 4.5 | 545 | 10 | 10.8 |
| Example 44 | 67.5 | 16.5 | 5.0 | 3.0 | 7.0 | 1.0 | 75.8 | 18.5 | 5.6 | 555 | 10 | 9.1 |
| Example 45 | 67.5 | 15.5 | 6.0 | 3.0 | 7.0 | 1.0 | 75.8 | 17.4 | 6.7 | 575 | 10 | 9.9 |
| Example 46 | 67.5 | 15.0 | 6.5 | 3.0 | 7.0 | 1.0 | 75.8 | 16.9 | 7.3 | 585 | 10 | 9.8 |
| Example 60 | 66.3 | 20.4 | 2.0 | 3.0 | 7.0 | 1.25 | 74.7 | 23.0 | 2.2 | 535 | 10 | 10.9 |
| Example 61 | 66.1 | 20.4 | 2.0 | 3.0 | 7.0 | 1.50 | 74.7 | 23.0 | 2.2 | 535 | 10 | 10.7 |
| Example 62 | 65.9 | 20.3 | 2.0 | 3.0 | 7.0 | 1.75 | 74.7 | 23.0 | 2.2 | 535 | 10 | 10.3 |
| Example 63 | 65.8 | 20.3 | 2.0 | 3.0 | 7.0 | 2.0 | 74.7 | 23.0 | 2.2 | 535 | 10 | 10.5 |
| Example 64 | 67.7 | 17.5 | 4.0 | 3.0 | 7.0 | 0.75 | 75.8 | 19.7 | 4.5 | 545 | 10 | 10.5 |
| Example 65 | 67.3 | 17.5 | 4.0 | 3.0 | 7.0 | 1.25 | 75.8 | 19.7 | 4.5 | 545 | 10 | 10.2 |
| Example 66 | 67.1 | 17.4 | 4.0 | 3.0 | 7.0 | 1.50 | 75.8 | 19.7 | 4.5 | 545 | 10 | 10.6 |
| Example 67 | 66.9 | 17.4 | 4.0 | 3.0 | 7.0 | 1.75 | 75.8 | 19.7 | 4.5 | 545 | 10 | 9.9 |
| Example 68 | 68.1 | 15.6 | 6.1 | 3.0 | 7.0 | 0.75 | 75.8 | 17.4 | 6.7 | 575 | 10 | 10.7 |
| Example 69 | 67.3 | 15.5 | 6.0 | 3.0 | 7.0 | 1.25 | 75.8 | 17.4 | 6.7 | 575 | 10 | 9.8 |
| Example 70 | 67.1 | 15.4 | 6.0 | 3.0 | 7.0 | 1.50 | 75.8 | 17.4 | 6.7 | 575 | 10 | 9.6 |
| Example 71 | 66.9 | 15.4 | 5.9 | 3.0 | 7.0 | 1.75 | 75.8 | 17.4 | 6.7 | 575 | 10 | 9.4 |
| Comparative | 73.3 | 16.5 | 0 | 3.0 | 6.0 | 1.0 | 81.7 | 18.3 | 0 | 550 | 60 | 12.2 |
| Example 14 | | | | | | | | | | | | |
| Reference | 66.5 | 21.5 | 1.0 | 3.0 | 7.0 | 1.0 | 74.7 | 24.2 | 1.1 | 535 | 10 | 11.9 |
| Example 1 | | | | | | | | | | | | |
| Reference | 66.3 | 21.4 | 1.0 | 3.0 | 7.0 | 1.25 | 74.7 | 24.2 | 1.1 | 535 | 10 | 11.6 |
| Example 2 | | | | | | | | | | | | |
| Reference | 66.1 | 21.4 | 1.0 | 3.0 | 7.0 | 1.50 | 74.7 | 24.2 | 1.1 | 535 | 10 | 12.3 |
| Example 3 | | | | | | | | | | | | |
| Reference | 66.7 | 20.6 | 2.0 | 3.0 | 7.0 | 0.75 | 74.7 | 23.0 | 2.2 | 545 | 10 | 11.9 |
| Example 4 | | | | | | | | | | | | |
| Comparative | 73.3 | 16.5 | 0 | 3.0 | 6.0 | 1.25 | 81.7 | 18.3 | 0 | 545 | 60 | 13.1 |
| Example 30 | | | | | | | | | | | | |
| Comparative | 73.1 | 16.4 | 0 | 3.0 | 6.0 | 1.50 | 81.7 | 18.3 | 0 | 545 | 60 | 12.4 |
| Example 31 | | | | | | | | | | | | |
| Comparative | 72.9 | 16.4 | 0 | 3.0 | 6.0 | 1.75 | 81.7 | 18.3 | 0 | 545 | 60 | 12.3 |
| Example 32 | | | | | | | | | | | | |
| Comparative | 72.7 | 16.3 | 0 | 3.0 | 6.0 | 2.0 | 81.7 | 18.3 | 0 | 545 | 60 | 11.9 |
| Example 33 | | | | | | | | | | | | |

*¹content ratio of Fe, Si and Al in the alloy composition, when the sum of the total content of Fe, Si and Al istaken as 100 at. %.

From Table 7 and FIG. 8, it is understood that there is a correlation between the average crystal grain size of the crystal grains and the c and y in the composition represented by the general formula (I), that is, the content ratio of Cu and Al constituting the clusters. For example, it is understood that the average crystal grain size of the crystal grains is about 11.3 nm if c=−34y+1.7, about 11.0 nm if c=−34y+2.2, and about 10.0 nm if c=−34y+3.2. Therefore, based on the above formula, it is possible to produce an Fe-based nanocrystalline soft magnetic alloy including crystal grains with a desired average crystal grain size.

### Example 72

A core of an Fe-based nanocrystalline soft magnetic alloy was obtained in the same manner as in Example 45, except that the width of the ribbon was 45 mm. After the obtained core was loaded in a resin case, a copper wire having a wire diameter of 1.6 mm was wound two turns around the resin case to prepare a common mode choke coil having a two-turn structure.

[Evaluation of Magnetic Components]

Table 8 shows the catalog values for the dimensions, number of turns, inductance, rated current, and DC resistance of a general-purpose common mode choke coil with a ferrite core (Ferrite Tokin SC-15-100, manufactured by Tokin Corporation).

Also, the DC resistance of the common mode choke coil of Example 72 was measured using a DC resistance meter (RM3545, manufactured by Hioki E.E. Corporation). Table 8 shows the dimensions, number of turns, inductance, rated current, and DC resistance of the common mode choke coil of Example 72. The dimensions in Example 72 are set so as to obtain the same inductance and rated current as those of the general-purpose common mode choke coil.

TABLE 8

| | | | general- |
|---|---|---|---|
| | | Example 72 | purpose coil |
| core | shape | FIG. 9 (a) | FIG. 9 (b) |
| | length | 45 | 45 |
| | [mm] | | |
| | width | 21 | 49 |
| | [mm] | | |
| | height | 21 | 27 |
| | [mm] | | |
| | weight | 45 | 100 |
| | [g] | | |

| | | |
|---|---|---|
| number of turns | 2 | 20 |
| inductance [mH] | 1 | 1 |
| ratd current [A] | 15 | 15 |
| DC resistance [mΩ] | 1.1 | 12 |

From Table 8, it is understood that with the common mode choke coil having a core formed of the Fe-based nanocrystalline soft magnetic alloy of Example 72, the same level of inductance and rated current as those of the general-purpose common mode choke coil can be achieved although the size is smaller than that of the general-purpose common mode choke coil. In addition, the common mode choke coil of Example 72 has light weight equal to or less than half the weight of the general-purpose common mode choke coil and also has low copper loss equal to or less than 10% of that of the general-purpose common mode choke coil. The above results show that the common mode choke coil using the Fe-based nanocrystalline soft magnetic alloy according to the present invention for a core is compact and has high performance, and can be practically used as a substitute for the conventional common mode choke coil.

1. An Fe-based nanocrystalline soft magnetic alloy comprising an amorphous phase and crystal grains, wherein
clusters are dispersed in the amorphous phase and the alloy has a composition represented by a following general formula (I),
(Fe_{1-x-y}SiₓAl_{y})_{100-a-b-c}MₐM′_{b}Cu_{c} (I)
wherein in the formula (I), M represents one or more elements selected from the group consisting of Nb, W, Zr, Hf, Ti and Mo; M′ represents one or more elements selected from the group consisting of B, C and P; a, b and c represent 2.0≤a≤5.0, 3.0<b<10.0 and 0<c<3.0, each in atomic %; and x and y represent 0.150≤x≤0.250 and 0.012≤y≤0.100 and satisfy 0.190≤x+y≤0.290.

2. The Fe-based nanocrystalline soft magnetic alloy according to claim 1, wherein
in the general formula (I), a represents 2.0<a<5.0 in atomic %, and x and y represent 0.160≤x≤0.250 and 0.023≤y≤0.090 and satisfy 0.210≤x+y≤0.280.

3. The Fe-based nanocrystalline soft magnetic alloy according to claim 1, wherein
in the general formula (I), x and y represent 0.170≤x≤0.240 and 0.040≤y≤0.070 and satisfy 0.210≤x+y≤0.280.

4. The Fe-based nanocrystalline soft magnetic alloy according to claim 1, wherein M is Nb and M′ is B.

5. The Fe-based nanocrystalline soft magnetic alloy according to claim 1, wherein atoms constituting the clusters are either one or both of Cu and Al.

6. The Fe-based nanocrystalline soft magnetic alloy according to claim 5, wherein the atoms constituting the clusters are both Cu and Al, and each cluster comprises both Cu and Al.

7. The Fe-based nanocrystalline soft magnetic alloy according to claim 1, wherein an average crystal grain size of the crystal grains is 11.3 nm or less.

8. The Fe-based nanocrystalline soft magnetic alloy according to claim 7, wherein in the general formula (I), c and y satisfy c≥−34y+1.7.

9. The Fe-based nanocrystalline soft magnetic alloy according to claim 1, wherein a number density of the clusters is 1.65×10⁻⁴/nm³ or more and 7.3×10⁻⁴/nm³ or less.

10. The Fe-based nanocrystalline soft magnetic alloy according to claim 1, wherein the number of magnetic domain walls is 15/mm or more and 50/mm or less.

11. A magnetic component comprising the Fe-based nanocrystalline soft magnetic alloy according to claim 1.

12. A method for producing the Fe-based nanocrystalline soft magnetic alloy according to claim 1, the method comprising:
an amorphous alloy preparation step of preparing an amorphous alloy by quenching and solidifying a molten metal having a composition represented by the general formula (I) by a rapid quenching method; and
a heat treatment step of performing nanocrystallization by heat-treating the amorphous alloy at 500° C. to 700° C. for 5 min to 5 h.

13. The method for producing the Fe-based nanocrystalline soft magnetic alloy according to claim 12, wherein a magnetic field is applied to the amorphous alloy during the heat treatment of the heat treatment step.

14. The method for producing the Fe-based nanocrystalline soft magnetic alloy according to claim 13, wherein an angle formed by a magnetic path of the amorphous alloy and a magnetic field application direction in the magnetic field application is within a range of 90°±15°.

15. The method for producing the Fe-based nanocrystalline soft magnetic alloy according to claim 13, wherein a magnetic field strength in the magnetic field application is 8 kA/m or more and 400 kA/m or less.

16. A method for producing an Fe-based nanocrystalline soft magnetic alloy, the method comprising:
an amorphous alloy preparation step of preparing an amorphous alloy by quenching and solidifying a molten metal having a composition represented by a general formula (II) by a rapid quenching method; and
a heat treatment step of performing nanocrystallization by heat-treating the amorphous alloy at 500° C. to 700° C. for 5 min to 5 h, wherein
a magnetic field is applied to the amorphous alloy during the heat treatment of the heat treatment step,
(Fe_{1-p-q}SiₚAl_{q})_{100-d-e-f}Q_{d}Q′ₑCu_{f} (II)
wherein in the formula (II), Q represents one or more elements selected from the group consisting of Nb, W, Zr, Hf, Ti and Mo; Q′ represents one or more elements selected from the group consisting of B, C and P; d, e and f represent 2.0≤d≤5.0, 3.0<e<10.0 and 0<f<3.0, each in atomic %; p and q represent 0.150≤p≤0.250 and 0.0020≤q≤0.012 and satisfy 0.190<p+q≤0.290.

17. The method for producing the Fe-based nanocrystalline soft magnetic alloy according to claim 16, wherein an angle formed by a magnetic path of the amorphous alloy and a magnetic field application direction in the magnetic field application is within a range of 90°±15°.

18. The method for producing the Fe-based nanocrystalline soft magnetic alloy according to claim 16, wherein a magnetic field strength in the magnetic field application is 8 kA/m or more and 400 kA/m or less.

19. The method for producing the Fe-based nanocrystalline soft magnetic alloy according to claim 14, wherein a magnetic field strength in the magnetic field application is 8 kA/m or more and 400 kA/m or less.

20. The method for producing the Fe-based nanocrystalline soft magnetic alloy according to claim 17, wherein a magnetic field strength in the magnetic field application is 8 kA/m or more and 400 kA/m or less.
